(19) United States
(12) Patent Application Publication
(10) Pub. No.: US 2022/0004709 A1
(43) Pub. Date: Jan. 6, 2022

(54) DEEP NEURAL NETWORK WITH COMPOSITIONAL GRAMMATICAL ARCHITECTURES

(71) Applicant: NORTH CAROLINA STATE UNIVERSITY, Raleigh, NC (US)

(72) Inventors: Tianfu WU, Cary, NC (US); Xilai LI, Raleigh, NC (US)

(21) Appl. No.: 17/293,980

(22) PCT Filed: Nov. 14, 2019
(86) PCT No.: PCT/US2019/061470

§ 371 Date: May 14, 2021

Related U.S. Application Data
(60) Provisional application No. 62/767,150, filed on Nov. 14, 2018.
(60) Provisional application No. 62/935,249, filed on Nov. 14, 2019.

(51) Int. Cl. G06F 40/253; G06K 9/62; G06N 3/04; G06F 16/901

(52) U.S. Cl. CPC G06F 40/253; G06F 16/9024; G06N 3/04; G06K 9/628

(57) ABSTRACT

The exemplified methods and systems provides deep neural network configured with a deep compositional grammatical architecture (e.g., to facilitate end-to-end representation learning). The instant deep compositional grammatical architecture beneficially integrates the compositionality and reconfigurability of grammar models with the capability of learning rich features of the deep neural networks in a principled way (e.g., for a convolutional neural network or a recombinant neural network). The instant deep compositional grammatical architecture utilizes AND-OR grammars to form an AND-OR grammar network.

### RELATED APPLICATION

This International PCT Patent Application claims priority to, and the benefit of, U.S. Patent Provisional Application No. 62/767,150, filed Nov. 14, 2018, titled “Deep Neural Network with Compositional Grammatical Architectures” and U.S. Patent Provisional Application No. 62/935,249, concurrently being filed on Nov. 14, 2019, titled “Deep Neural Network with Compositional Grammatical Architectures”, each of which is incorporated by reference herein in its entirety.

### GOVERNMENT LICENSE RIGHTS

This invention was made with government support under grant numbers W911NF-18-1-0209 and W911NF-18-1-0295 awarded by the U.S. Army Research Office. The government has certain rights in the invention.

### BACKGROUND

Deep neural networks (DNN), also known as deep structured learning or hierarchical learning, are a part of a broad class of machine learning methods based on learning data representations. Deep neural networks have improved prediction accuracy significantly in many vision tasks, and even obtained superhuman performance in certain image classification tasks. Much of these progress may have been achieved mainly through development of engineering network architectures that has increasing representational power (e.g., by having either deeper and/or wider networks) that can be back-propagated with techniques such as stochastic gradient descent (e.g., to handle the vanishing and/or exploding gradient problem).

Although network engineering has been an active part of neural network research since its initial development, the fundamental architecture of deep neural networks is still similar to that pioneered by Fukushimas as described in K. Fukushima, “Neocognitron: A self-organizing neural network model for a mechanism of pattern recognition unaffected by shift in position,” Biological cybernetics, 36(4):193-202, 1980.

Although deep neural networks such as convolutional neural networks (CNNs) and recurrent neural networks (RNNs) have demonstrated outstanding levels of performance at object and speech recognition tasks, alternative neural architectures can further improve upon the performance of deep neural networks (DNN).

### SUMMARY

The exemplified methods and systems provides deep neural network configured with a deep compositional grammatical architecture (e.g., to facilitate end-to-end representation learning). The instant deep compositional grammatical architecture beneficially integrates the compositionality and reconfigurability of grammar models with the capability of learning rich features of the deep neural networks in a principled way (e.g., for a convolutional neural network or a recombinant neural network). The instant deep compositional grammatical architecture utilizes AND-OR grammars (referred to herein as “AOG”) to form an AND-OR grammar network (referred to herein as “AOGNet”).

The AND-OR grammar network includes one or more stages in which each stage includes one or more AND-OR-grammar building blocks. In some embodiments, the AND-OR grammar building block has split inputs that span across an input feature map. That is, a given AND-OR grammar building block splits its input feature map into N groups (in which each group is also referred to as a “word” or a “phrase” or a “sub-word”) along a given feature channel and then treats the channel a sentence of N words (or phrases or sub-words). In some embodiments, the instant AND-OR-grammar building block realizes, i.e., configured with, both a phrase structure grammar and a dependency grammar in a bottom-up configuration for parsing a given input channel (i.e., “sentence”). for better feature exploration and exploitation.

In an aspect, a computer-implemented method is disclosed (e.g., to generate a deep neural network structure that solves a provided problem when trained on a source of training data containing labeled examples of data sets for the problem). The method includes instantiating one or more compositional grammatical neural network node layers, wherein at least one of the one or more compositional grammatical neural network node layer comprises a AND-OR grammar building block, wherein the AND-OR grammar building block comprises an input that maps N groups of input-able features (e.g., via a terminal node configured to extract a word, sub-word, phrase, or sub-phrase) from one or more feature channels, and wherein the AND-OR grammar building block comprises a graph of stacked and interconnected plurality of AND nodes (e.g., node configured to concatenate features from connected child nodes) and plurality of OR nodes (e.g., node configured to element-wise sum features from connected child nodes) that connects in a set of combinations of AND nodes and OR nodes to the N groups of inputted features of each of the one or more feature channels.

In some embodiments, the graph of interconnected plurality of AND nodes (e.g., concatenation nodes) and plurality of OR nodes are configured in a plurality of stacked stages, including a first stage followed by a second stage, wherein the first stage comprises at least one AND-node, and wherein the second stage comprises at least one OR-node.

In some embodiments, the graph of interconnected plurality of AND nodes (e.g., concatenation nodes) and plurality of OR nodes are configured in a plurality of stacked stages, including a first stage followed by a second stage, wherein the first stage comprises at least one OR-node, and wherein the second stage comprises at least one AND-node.

In some embodiments, the first stage comprises a first OR-node and a second OR-node, wherein the first OR-node is connected to a portion of the input, and wherein the second OR-node is connected to another portion of the input and to the first OR-node (e.g., as a dependency grammar).

In some embodiments, the first stage comprises a first OR-node and a second OR-node, wherein the first OR-node is connected to a portion of the input, and wherein the second OR-node is connected to another portion of the input (e.g., phrase structure grammar only).

In some embodiments, the first stage comprises a first OR-node and a second OR-node, wherein the first OR-node is connected to a portion of the input, and wherein the second OR-node is connected to another portion of the input (e.g., phrase structure grammar only).

In some embodiments, the AND-OR grammar building block comprises a first hyper-parameters associated with a number of N groups (e.g., number of words, N) of input-able features.

In some embodiments, the AND-OR grammar building block comprises a second hyper-parameters (e.g., k) associated with a branching factor for each AND-nodes in the AND-OR grammar building block.

In some embodiments, the AND-OR grammar building block comprises a third hyper-parameters associated with i) phase structure grammar only and ii) a combination of phase structure grammar and dependency grammar.

In some embodiments, the AND-OR grammar building block comprises a fourth hyper-parameters associated with i) full phrase structure and ii) a partial phrase structure that do not include syntactically symmetric child nodes.

In some embodiments, the one or more compositional grammatical neural network node layers are instantiated in a convolutional neural network selected from the group consisting of GoogLeNets, ResNets, ResNeXts, DenseNets, and DualPathNets.

In some embodiments, the generated deep neural network structure comprises a second compositional grammatical neural network node layer, wherein the second compositional grammatical neural network node layer comprises a AND-OR grammar building block, wherein the AND-OR grammar building block comprises an input that maps N groups of input-able features (e.g., via a terminal node configured to extract a word, sub-word, phrase, or sub-phrase) from one or more feature channels, and wherein the AND-OR grammar building block comprises a graph of stacked and interconnected plurality of AND nodes (e.g., node configured to concatenate features from connected child nodes) and plurality of OR nodes (e.g., node configured to element-wise sum features from connected child nodes) that connects in a set of combinations of AND nodes and OR nodes to the N groups of inputted features of each of the one or more feature channels.

In some embodiments, the generated deep neural network structure comprises one or more Conv-BatchNorm-ReLu stage (e.g., or other front-end stages) that connects to a first instantiated compositional grammatical neural network node layer.

In some embodiments, the one or more compositional grammatical neural network nodes comprises a second AND-OR grammar building block.

In some embodiments, the method further includes classifying an image (e.g., B/W, color, video) using the instantiated one or more neural network nodes (e.g., wherein the one or more neural network nodes are part of a convolutional neural network).

In some embodiments, the method further includes classifying a linguistic text body (e.g., from a document) using the instantiated one or more neural network nodes (e.g., wherein the one or more neural network nodes are part of a recombinant neural network).

In some embodiments, an N group of inputted features of at least one of the one or more feature channels includes at least two number of input groups.

In another aspect, a computer-implemented system is disclosed (e.g., to generate a deep neural network structure that solves a provided problem when trained on a source of training data containing labeled examples of data sets for the problem). The system includes a processor (e.g., CPU or GPU); and a memory having instructions stored thereon, wherein execution of the instructions by the processor causes the processor to perform any of the above-recited methods.

In another aspect, a non-transitory computer readable medium is disclosed. The computer readable medium comprises instructions stored thereon, wherein execution of the instructions by a processor causes the processor to perform any of the above-recited methods.

In another aspect, a computer-implemented system is disclosed (e.g., to generate a deep neural network structure that solves a provided problem when trained on a source of training data containing labeled examples of data sets for the problem). The system includes a processor (e.g., CPU or GPU); and a memory having instructions stored thereon, wherein execution of the instructions by the processor causes the processor to instantiate a compositional grammatical neural network node layer one or more AND-OR grammar building block means.

### BRIEF DESCRIPTION OF DRAWINGS

Embodiments of the present invention may be better understood from the following detailed description when read in conjunction with the accompanying drawings. Such embodiments, which are for illustrative purposes only, depict novel and non-obvious aspects of the invention. The drawings include the following figures:

FIG. 1 is a diagram of a system (referred to herein as “AND-OR grammar network”, i.e., “AOGNet”) configured with a compositional grammatical neural network node layer 102, in accordance with an illustrative embodiment.

FIG. 2A is a diagram showing a concatenate feature operation of the AND-node in accordance with an illustrative embodiment.

FIG. 2B is a diagram showing a sum feature operation of the OR-node in accordance with an illustrative embodiment.

FIG. 2C is a diagram showing a grounding feature operation of the terminal-node, in accordance with an illustrative embodiment.

FIG. 3A is a diagram showing a simplified representation of the AOG building block of FIG. 1 in accordance with an illustrative embodiment.

FIG. 3B is a diagram of an AOG building block configured with both lateral connections and pruned structure, in accordance with an illustrative embodiment.

FIG. 4A shows an algorithm that can generate the AOG building block of FIG. 1 (and 3A) with lateral connections, in accordance with an illustrative embodiment.

FIG. 4B shows an algorithm that can generate the AOG building block of FIG. 3A using the breadth-first search (BFS) order in accordance with an illustrative embodiment.

FIG. 5 is a diagram showing an AOG network configured with multiple stages, in accordance with an illustrative embodiment.

FIG. 6 shows an example of a bottleneck operator in accordance with an illustrative embodiment.

FIGS. 7A-7B, 8A-8D, 9A-9D, 10A-10D, 11A-11D, 12A-12D, and 13A-13D each shows variants of AOG building blocks based on a particular set of hyperparameters, in accordance with an illustrative embodiment.

FIG. 14 shows a diagram of an AOG network in which a set of AOG building blocks are provided as word inputs to a later stage AOG building block (e.g., referred to as “AOGNet-in-AOGNet”), in accordance with an illustrative embodiment.

FIG. 15 is a diagram of a compositional stacking AOG building block configuration as a recurrent AOGNet for natural language processing (NLP) tasks in accordance with an illustrative embodiment.

FIG. 16 is a diagram illustrating the design methodology of the compositional grammatical neural network node layers, in accordance with an illustrative embodiment.

FIG. 17 is a diagram showing a building block based approaches to explore the structure space and node operation space of the compositional grammatical neural network node layers, in accordance with an illustrative embodiment.

FIG. 18 is a diagram showing examples of alternative building blocks employed in GoogLeNets, ResNets, ResNeXts, DenseNets, and DualPathNets, in accordance with an illustrative embodiment.

FIG. 19 shows experimental results for AOGNets in ImageNet.

FIG. 20 shows experimental results of model interpretability of AOGNet using a network dissection method on ImageNet pretrained networks.

FIG. 21 is a diagram of an example computing device upon which embodiments may be implemented, in accordance with an illustrative embodiment.

### DETAILED SPECIFICATION

Each and every feature described herein, and each and every combination of two or more of such features, is included within the scope of the present invention provided that the features included in such a combination are not mutually inconsistent.

Exemplary AOGNet System

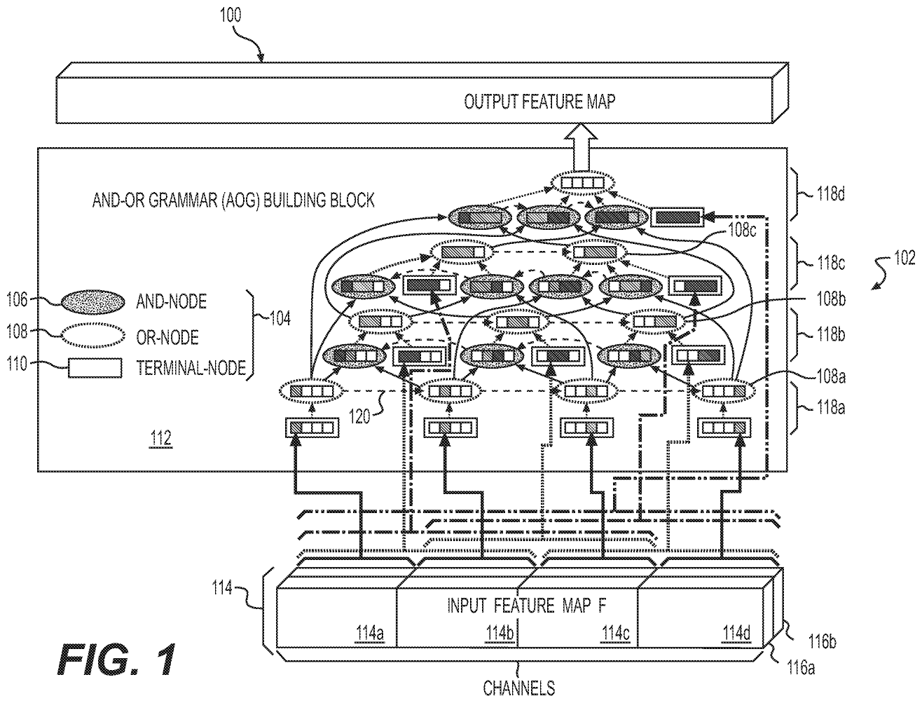

FIG. 1 is a diagram of a system 100 (referred to herein as “AND-OR grammar network”, i.e., “AOGNet”) configured with a compositional grammatical neural network node layer 102, in accordance with an illustrative embodiment. The compositional grammatical neural network node layers 102 utilize a plurality of AND-OR grammar (“AOG”) primitives 104, including AND-nodes 106, OR-nodes 108, and terminal nodes 110, that are arranged in a hierarchical combination to form an AND-OR grammar building block 112 (“AOG building block”). That is, the AOG building block 114 can be structured based on AOG primitives 104 that are organized in in a hierarchical and compositional AND-OR graph. A system can instantiate one or more of the AND-OR grammar building block 112 to form the AND-OR grammar network 100.

As shown in FIG. 1, the AND-OR grammar building block 112 has a plurality of split inputs that span across feature channels of an input feature map 114 (shown as 114a, 114b, 114c, and 114d). Indeed, the input feature map 114 includes N groups along a given feature channel 116 (shown as 116a, 116b). Each group (i.e., as an element of N) can be referred to as a “word”, “phrase” or a “sub-word” and a channel can be referred to as a sentence, i.e., of N words (or phrases or sub-words).

An AOGNet consists of M stages (M≥1). A stage l comprises a small number nₗ of AOG building blocks (l∈[0, M−1] and nₗ≥1]). Both M and nₗ's are predefined for a given task in learning. In an AOG building block 112, all AOG primitives 104 are configured with, or predominantly with, the sample type of transformation function [symbol] (⋅). In some embodiments, the transformation function [symbol] (⋅) is implemented as a Conv-BatchNorm-ReLU transformation or a variant of the bottleneck (BN) operator, e.g., as described in K. He, X. Zhang, S. Ren, and J. Sun, “Deep residual learning for image recognition,” IEEE Conference on Computer Vision and Pattern Recognition (CVPR), 2016, which is incorporated by reference herein in its entirety.

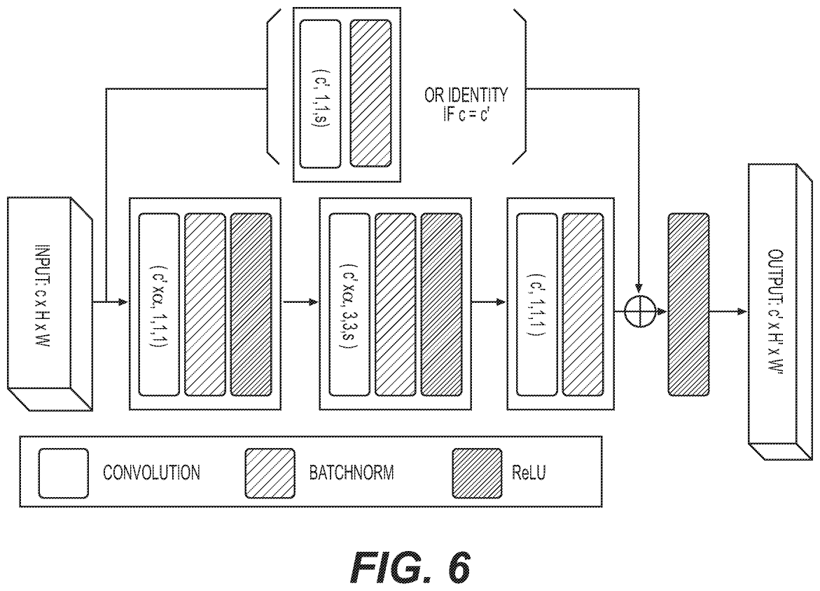

FIG. 6 shows an example of a bottleneck operator in accordance with an illustrative embodiment. The 4-tuple of convolution represents (number of channels, kernel height, kernel width, stride). The bottleneck ratio is α (e.g., α=0:25). The stride s is determined by the spatial sizes of input and output feature maps. Other operators can be used such as convolutions and group convolutions.

Where the input and output of an AND-node or an OR-node, v_{i,j}, have the same dimensionalities, the following relationship may apply: c_{i,j}^{v}× [symbol] × [symbol] and

$${c}_{i , j}^{v} = k \times \frac{ℂ}{N} .$$

In learning and inference, the system, in some embodiments, follows the depth-first search (DFS) order to compute nodes in an AOG building block, which ensures that all the child nodes have been computed when the system computes a node v.

AOG AND-Node

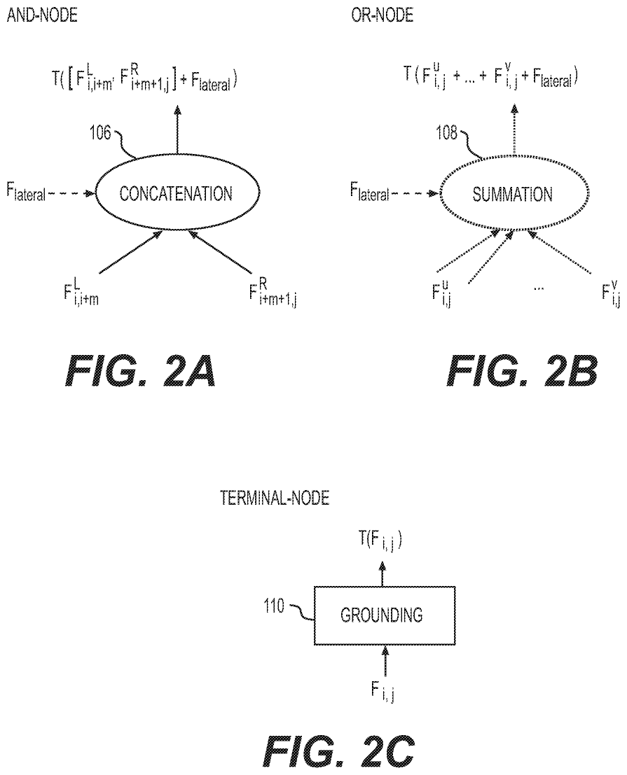

The AOG building primitive AND-node 106 of the AND-OR-grammar building block 112 is configured to concatenate features from syntactic child nodes connected to the inputs of the AND-node 106 (e.g., for feature exploration). FIG. 2A is a diagram showing a concatenate feature operation of the AND-node 106 in accordance with an illustrative embodiment. As shown in FIG. 2A, the AND-node 106, is configured to concatenate features of syntactic child nodes that are connected to its inputs and from lateral connections (e.g., from other AND-nodes in a same stage or set of the building block). The phrase structure grammar component, in some embodiments, is a modified version natural language processing according to a binary composition rule. The dependency grammar component is integrated to capture lateral connections and improve the representational flexibility and power.

In some embodiments, for an AND-node A_{i,j}(m), the input of the AND-node is computed by the concatenation of the outputs of its two syntactic child nodes, f_{i,i+m}^{L} and f_{i+m+1,j}^{R} to provide an output as shown in Equation 1.

f_{i,j}^{A}=[f_{i,i+m}^{L},f_{i+m+1,j}^{R}] (Equation 1)

If the AND-node is configured with lateral child node whose output is denoted as fₗₐₜₑᵣₐₗ^{A}, then the output is shown in Equation 2.

f_{i,j}^{A}=[f_{i,i+m}^{L},f_{i+m+1,j}^{R}]+fₗₐₜₑᵣₐₗ^{A} (Equation 2)

AOG OR-Node

The AOG building primitive OR-node 108 of the AND-OR-grammar building block 112 is configured to perform an element-wise sum of features from syntactic child nodes connected to the inputs of the OR-node 108 (e.g., for feature exploitation). FIG. 2B is a diagram showing a sum feature operation of the OR-node 108 in accordance with an illustrative embodiment. As shown in FIG. 2B, the OR-node 108, is configured to concatenate features of syntactic child nodes that are connected to its inputs and from lateral connections (e.g., from other OR-nodes in a same stage or set of the building block). The phrase structure grammar component can be understood as a modified version natural language processing according to a binary composition rule. The dependency grammar component is integrated to capture lateral connections and improve the representational flexibility and power.

In some embodiments, for an OR-node O_{i,j}(m), the input of the OR-node is computed by the summation of the outputs of its two syntactic child nodes to provide an output as provided in Equation 3.

f_{i,j}^{O}=Σᵤ_{_{i,j}}_{∈ch(O}_{_{i,j}}₎f_{i,j}^{u} (Equation 3)

where ch(⋅) is the set of child nodes.

If the OR-node is configured with lateral child node whose output is denoted as fₗₐₜₑᵣₐₗ^{O}, then the output is shown in Equation 4.

f_{i,j}^{O}=Σᵤ_{_{i,j}}_{∈ch(O}_{_{i,j}}₎f_{i,j}^{u}+fₗₐₜₑᵣₐₗ^{O} (Equation 4)

AOG Terminal-Node

The terminal-node 110 is configured to input a k-gram phrase consisting of k words, e.g., a slice of the feature map with the number of channels being k, where 1≤k≤N. FIG. 2C is a diagram showing a grounding feature operation of the terminal-node 110, in accordance with an illustrative embodiment. As shown in FIG. 2C, a terminal-node, t_{i,j} can be denoted by F_{i,j} and has a corresponding k-gram chunk in the input feature map F. The input of the terminal node can be characterized as f_{i,j}^{t}=F_{i,j} with the dimensionality c_{i,j}^{v}×H×W. The output of the terminal node can be characterized Equation 5 with the dimensionality c_{i,j}^{v}× [symbol] × [symbol] , where c_{i,j}^{v}=k×c and

$${c}_{i , j}^{v} = k \times \frac{ℂ}{N} .$$

f_{i,j}^{t}= [symbol] (F_{i,j}) (Equation 5)

Indeed, the terminal-nodes implement the split-transform heuristic (or group convolutions) as skip-connection at multiple levels. In contrast, non-terminal nodes (e.g., AND-nodes and OR-nodes) implement aggregation operation.

As shown in FIG. 1, each of the sets 118a, 118b, 118c, and 118d includes one or more terminal nodes 110 each configured to select or output a channel-wise slice (e.g., a k-gram), i.e., of groups 114 of a given input channel 116 to an AOG building primitive 104. In an alternative embodiment, the AOG building primitives 104 can be implemented with a function to select or output a channel-wise slice (114) of a given input channel 116—that is, the AOG building primitives 104 can be implemented with the terminal-node front end.

AOG Feature Channel

As illustrated in FIG. 1, an AOG building block maps, in some embodiments, an input feature map F with the dimensionality number of channels (C)×height (H)×width (W) to a feature map [symbol] with the dimensionality [symbol] × [symbol] × [symbol] . The system treats the input feature map as a sentence of N words. Each word can represent a primitive feature map with the dimensionality c× [symbol] × [symbol] with the input, satisfying C=N×c. In implementation, following a common convention, the system usually reduce the spatial size and increase the number of channels between consecutive stages for bigger receptive field and greater expressive power. Within a stage, the system may keep the dimensionalities of input and output same for the AOG building blocks except for the first one.

The number of input groups N (114) can have a minimum value of 2. The maximum value of N is task-dependent, for example, in image applications, N=20 may be a good upper boundary, and for linguistic applications, N=the length of inputted text body may be the maximum depends on the length of input. The number of channels 116 can have a minimum value of “1” and the maximum number of channels can be up to 2048 channels (e.g., as would be constrained by memory footprint of the hardware, e.g., CPU main memory and GPU memory).

The graph of AOG building primitives 104 are configured to provide all possible parsing combinations across each of the channels 116 only—that is, the combination are not across the channels. In other embodiments, the graph of the AOG building primitives 104 are configured to provide all possible parsing and combinations across multiple channels 116, including intra-channel (as shown in FIG. 1) and intra-channel (not shown).

The phrase structure grammar in constructing an AOG building block: the system may follow three rules in unfolding the configurations of a sentence with N words per Equations 6, 7, and 8.

S_{i,j}→t_{i,j} (Equation 6)

S_{i,j}(m)→L_{i,i+m}·R_{i+m+1,j},0≤m<k (Equation 7)

S_{i,j}→S_{i,j}(0)|S_{i,j}(1)| . . . |S_{i,j}(j−i)| (Equation 8)

where S_{i,j} represents a symbol for unfolding the sub-sentence starting at the i-th word (i∈[0, N−1]) and ending at the j-th word (j∈[0, N−1], j≥i) and its length equals k=j−i+1.

According to Equation 1, the first rule is a termination rule which grounds the non-terminal symbol S_{i,j} directly to the corresponding sub-sentence t_{i,j}, i.e., a k-gram terminal symbol, which is represented by a Terminal-node in the AND-OR graph.

According to Equation 2, the second rule is a binary decomposition (or composition) rule which decomposes the non-terminal symbol S_{i,j} into two child symbols representing a left sub-sentence and a right sub-sentence respectively: L_{i,i+m} and R_{i+m+1,j}, both of which are either a non-terminal symbol or a terminal symbol depending on m. It is represented by an AND-node in the AND-OR graph and entails the concatenation scheme in forward computation.

According to Equation 3, the third rule represents alternative ways of decomposing a symbol S_{i,j}, which is represented by an OR-node in the AND-OR graph and entails summation scheme in forward computation to “integrate out” the decomposition structures.

Indeed, conceptually, an AOG building block embodies an exploration-and-exploitation-driven compositional structure for representation learning by DNNs.

Further description of the general AND-OR grammar framework is provided in S. C. Zhu and D. Mumford, A stochastic grammar of images,” Foundations and Trends in Computer Graphics and Vision, 2(4):259-362, 2006 and in L. Zhu, Y. Chen, Y. Lu, C. Lin, and A. L. Yuille, “Max margin AND/OR graph learning for parsing the human body,” In 2008 IEEE Computer Society Conference on Computer Vision and Pattern Recognition (CVPR), 2008, each of which is incorporated by reference herein in its entirety.

Referring back to FIG. 1, an AND-OR-grammar building block 112 can be configured with both a phrase structure grammar-based structure (having a vertical compositions) and a dependency grammar-based structure (having a lateral connections) in a bottom-up configuration for parsing a given input channel 116. The AOG building primitives 104 can be structured, via the phrase structure grammar and the dependency grammar-based structure, to provide all possible parsing combination of a channel 116 (i.e., “sentence”). Further, the graph of interconnected plurality of AND nodes (e.g., concatenation nodes) and plurality of OR nodes (sum nodes) are configured in a plurality of stacked stages, including a first stage followed by a second stage, wherein the first stage comprises at least one AND-node or at least one OR-node, and wherein the second stage comprises a corresponding OR-node or a corresponding AND-node. As shown in FIG. 1, a first set 118a of AOG building primitives 104 (comprising a set of OR-nodes) receives 1−N length inputs at positions 0, 1, 2, and 3 of channel 116a (where the channel is referenced from ‘0” having N=4); a second set 118b of AOG building primitives 104 receives 2−N length inputs at positions 0, 1, and 2 of channel 116a; a third set 118c of AOG building primitives 104 receives 3−N length inputs at position 0 and 1 of channel 116a, and a fourth set 118d of AOG building primitives 104 receives 4−N length inputs at position 0 of channel 116a. The OR-nodes of the first set 118a each has a single input from a terminal node and have a set of lateral connections that sum to a last node 108a of the first set 118a. The outputs of the OR-nodes of the first set 118a are concatenated by sets of AND-nodes that are parent nodes in the first set, second set, and third set; the AND-nodes of the first set 118a have lateral connections to other AND-nodes in the same set. The OR-nodes of the second set 118b each has a dual input from a terminal node and a child AND-node from the first set 118a and have a set of lateral connections that sum to a last node 108b of the second set 118b. The outputs of the OR-nodes of the second set 118b are concatenated by a set of AND-nodes that are parent nodes in the second set and the third set; the AND-nodes of the second set 118b have lateral connections to other AND-nodes in the same set. The OR-nodes of the third set 118c each has three inputs from a terminal node and two child AND-nodes from the second set 118b and have a set of lateral connections that sum to a last node 108c of the third set 118c. The outputs of the OR-nodes of the third set 118c are concatenated by a set of AND-nodes that have lateral connections to other AND-nodes in the set. The OR-nodes of the fourth set 118d has four inputs from a terminal node and three child AND-nodes. The output of the OR-nodes of the fourth set 118c is mapped to an output feature map. Indeed, the graph of AOG building primitives 104 are configured to provide all possible parsing combinations across each of the channels 116.

As shown in FIG. 1, because the output feature map can have a smaller spatial size through the sub-sampling used in the terminal-node operations (or selection operation) and a larger number of feature channels, the AOG building block can be stacked to form deep hierarchy. Further, the hierarchy facilitates gradual increase of feature channels and provides a good balance between depth and width in the network architecture.

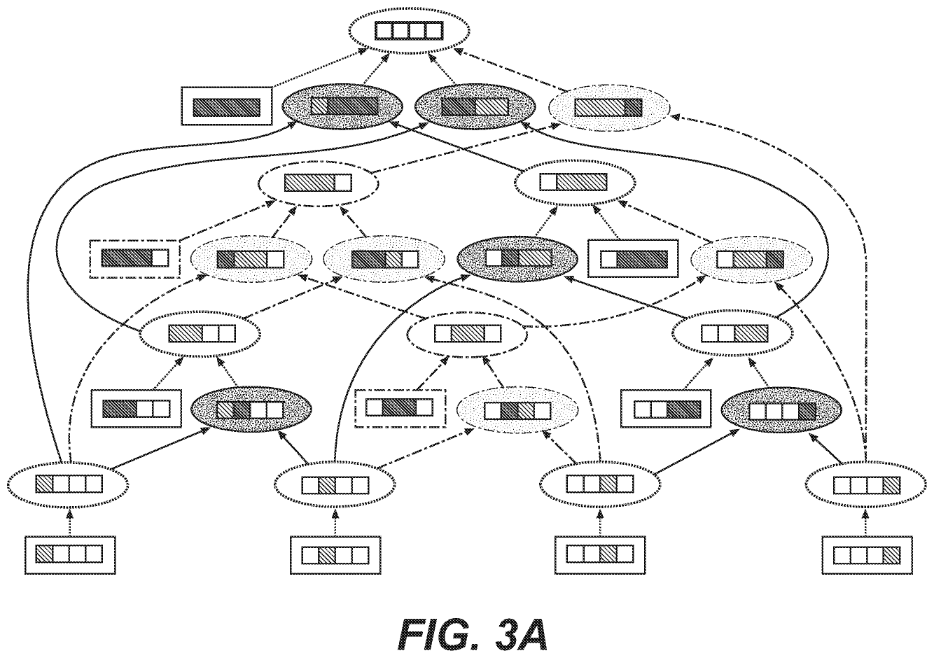

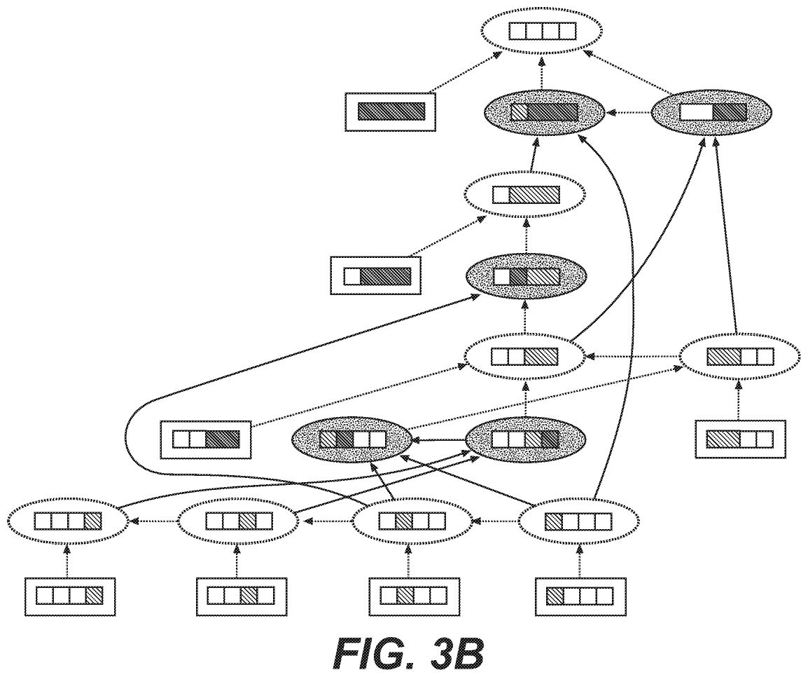

The dependency grammar in constructing an AOG building block: the system can include dependency grammar to model lateral connections between non-terminal nodes of the same type (AND-node or OR-node), for example, with the same length (i.e., k=j−i+1 in the three rules). As illustrated by in FIG. 1, the system can add lateral connections (120) in a number of ways: (i) for the set of OR-nodes with k∈[1, N−1], the system first sorts them based on the starting index i; and (ii) for the set of AND-nodes with k∈[2, N], the system first sort them based on the lexical orders of the pairs of starting indexes of the two child nodes. Then, the system adds sequential lateral connections for nodes in the sorted set either from left to right or from right to left. The system usually use opposite lateral connection directions for AND-nodes and OR-nodes to have globally consistent lateral flow from bottom-to-top in an AOG building block. FIG. 3B is a diagram of an AOG building block configured with both lateral connections and pruned structure, in accordance with an illustrative embodiment.

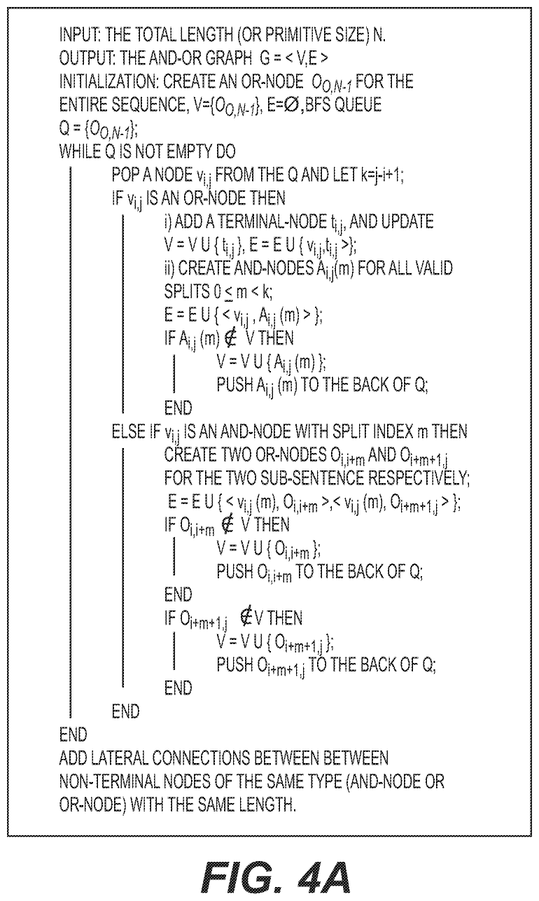

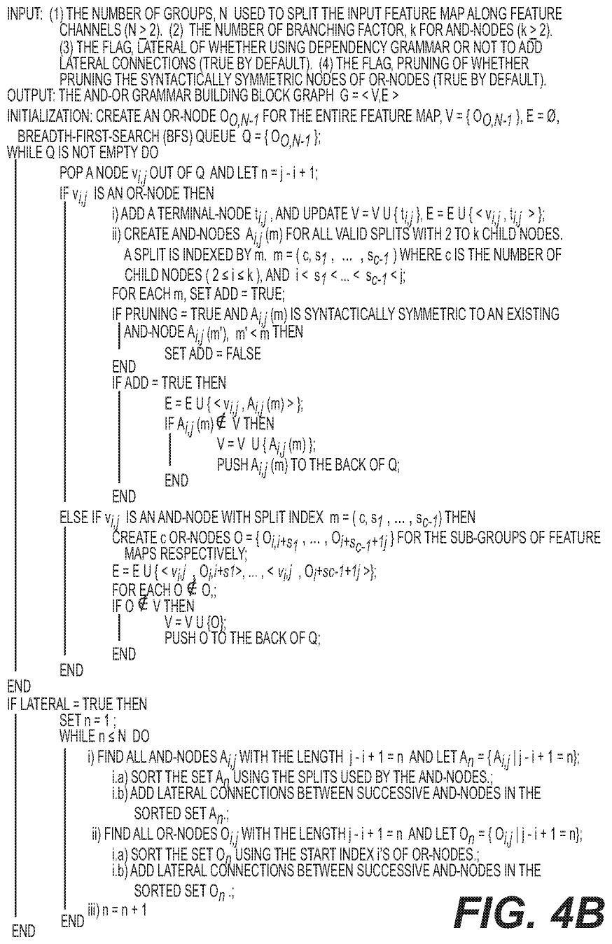

FIG. 4A shows an algorithm that can generate the AOG building block of FIG. 1 (and 3A) with lateral connections, in accordance with an illustrative embodiment. As shown in FIG. 4A, the AOG primitives 104 can be instantiated in the AOG building block within a while loop. The function of adding the lateral connections can be performed after the AOG primitives 104 are instantiated. The AOG structure inherently embraces the skip-connection for words (chunks of feature maps) and the sentence itself (the entire input feature map) in a hierarchical and compositional manner that goes beyond the pure skip-connection, the pure dense connection, and sequential combination.

Pruning the full structure of an AOG building block: In another aspect, the AOG building block can adopt a pruning method, e.g., that follows the breadth-first search (BFS) order of nodes and for each encountered OR-node the system only keeps the child nodes which does not have left-right syntactically symmetric counterparts in the current set of child nodes. For example, consider the four child nodes of the root OR-node in FIG. 1, the fourth child node is removed since it is symmetric to the second one. Following the BFS rule, the system extracts the sub-AOG structure to be preserved. FIG. 3A is a diagram showing a simplified representation of the AOG building block of FIG. 1 in accordance with an illustrative embodiment. FIG. 3B is a diagram showing a pruned version of the AOG building block of FIG. 3A in accordance with an illustrative embodiment.

For example, the system instantiates 10 terminal-nodes, 10 AND-nodes, and 10 OR-nodes for an AOG building block with N=4 as shown in FIG. 1. After pruning, the AOG building block has 8 terminal-nodes, 5 AND-nodes, and 8 OR-nodes as shown in the right of FIG. 2.

FIG. 4B shows an algorithm that can generate the AOG building block of FIG. 3A using the breadth-first search (BFS) order in accordance with an illustrative embodiment. As provided in algorithm of FIG. 4B, the AND-OR grammar building block 112 can be configured via a set of hyperparameters, including a first that is associated with a number of N groups of input-table features, a second associated with a branching factor for each of the AND-nodes in the building block, a third hyperparameter associated with the configuration having dependency grammar or not having dependency grammar, and fourth hyperparameter associated with the configuration having a full structure or a partial structure for OR-nodes.

Indeed, the AOG network can be instantiated based on a single hyperparameter (as demonstrated in FIG. 4A) as well as in combination of multiple hyperparameters as provided in FIG. 4B.

AOG Network with Multiple AOG Stages

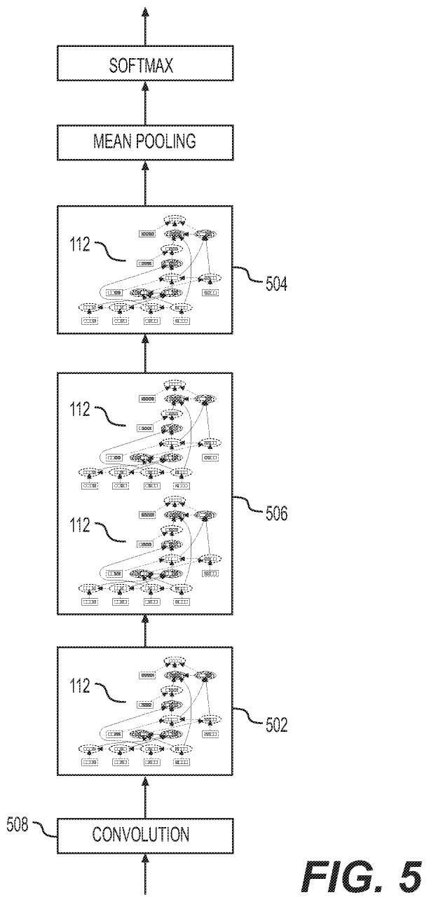

FIG. 5 is a diagram showing an AOG network configured with multiple stages, in accordance with an illustrative embodiment. Specifically, FIG. 5 shows an AOGNet configured with stages M=3, in which the first stage n₁ (502) and third stage n₃ (504) each includes a single AOG building block (112) (i.e., n₁=n₃=1) and in which the second stage n₂ (506) has double AOG building blocks (i.e., n₂=2).

In some embodiments, each stage of the AOG network has the same AOG building blocks. In other embodiments, each stage of the AOG network has the same number and type of AOG building blocks. In yet other embodiments, each stage of the AOG network has a different AOG building block configuration.

As shown in FIG. 5, the AOG network can include one or more front-end stage 508 (e.g., convolution stage such as Conv-BatchNorm-ReLu) located before the first AOG stage. Indeed, the AOG network can be integrated with any other networks, such as GoogLeNets, ResNets, ResNeXts, DenseNets, and DualPathNets.

Hyperparameters and AOGNet Configuration

Indeed, variants of AOG building blocks can be generated by varying the hyperparameters and variants of AOGNets can be generated by stacking AOG building blocks in different ways. Further extension of AOGNets on language modeling tasks can be performed. Table 1 shows a set of hyperparameters that are used to generate an AOG building block per the algorithm of FIG. 4B.

TABLE 1

| Number of words, N | {N = 2, 3, 4, 5} |
|---|---|
| Number of branching factor, k | {k = 2, 3} |
| Phase structure grammar vs. Phrase structure + | {0, 1} |
| dependency grammar | |
| Full phrase structure vs. pruned phrase structure | {0, 1} |

As provided in Table 1, variants of the AOG build block can be expressed in terms of four hyper-parameters of less.

The first hyperparameter is associated with a number of words, N, in treating an input feature map as a sentence. Examples are provided for N=2, 3, 4, 5, though other values of N can be used. As noted above, N has a minimum value of 2 and can be of any size.

The second hyperparameter is associated with a number, k, of branching factors for AND-nodes in the building block (k≤N). By default, k=2, that is to use binary splitting rule. Examples are also provided for k=3, which introduce an extra AND-nodes which have 3 child nodes.

The third hyperparameter is associated the structure having phrase structure grammar only or a phrase structure grammar in combination with dependency grammar.

The fourth hyperparameter is associated the structure having a full phrase structure or a pruned phrase structure. As noted above, pruning may be performed for OR-nodes recursively, e.g., from top to bottom to remove syntactically symmetric child nodes of the OR-nodes.

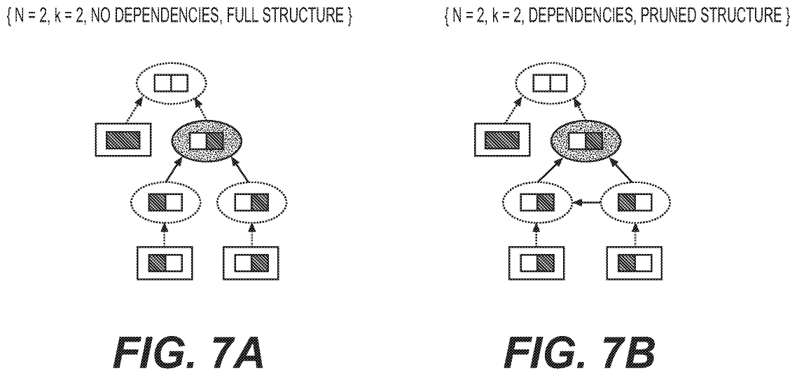

FIGS. 7A-7B, 8A-8D, 9A-9D, 10A-10D, 11A-11D, 12A-12D, and 13A-13D each shows variants of AOG building blocks based on a particular set of hyperparameters, in accordance with an illustrative embodiment.

FIG. 7A shows an AOG building block with N=2, k=2, lateral connection=0. FIG. 7B shows an AOG building block with N=2, k=2, lateral connection=1. Because there are no symmetric child nodes found for OR-nodes, the full structure and the pruned structure are the same.

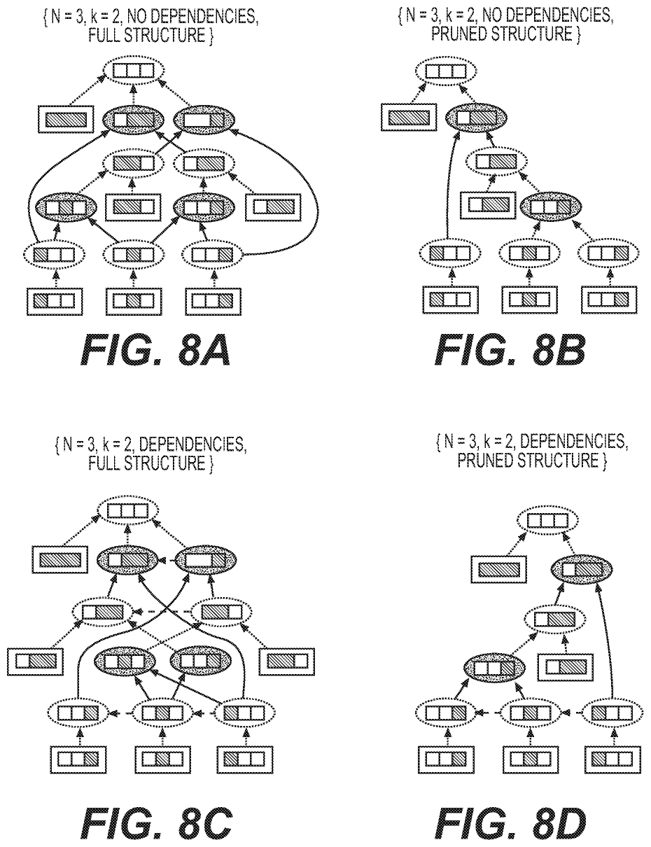

FIG. 8A shows an AOG building block generated from the algorithm of FIG. 4B configured with hyperparameters N=3, k=2, lateral connection=0, with pruned structure=0. FIG. 8B shows an AOG building block generated from the algorithm of FIG. 4B configured with hyperparameters N=3, k=2, lateral connection=0, with pruned structure=1. FIG. 8C shows an AOG building block generated from the algorithm of FIG. 4B configured with hyperparameters N=3, k=2, lateral connection=1, with pruned structure=0. FIG. 8D shows an AOG building block generated from the algorithm of FIG. 4B configured with hyperparameters N=3, k=2, lateral connection=1, with pruned structure=1.

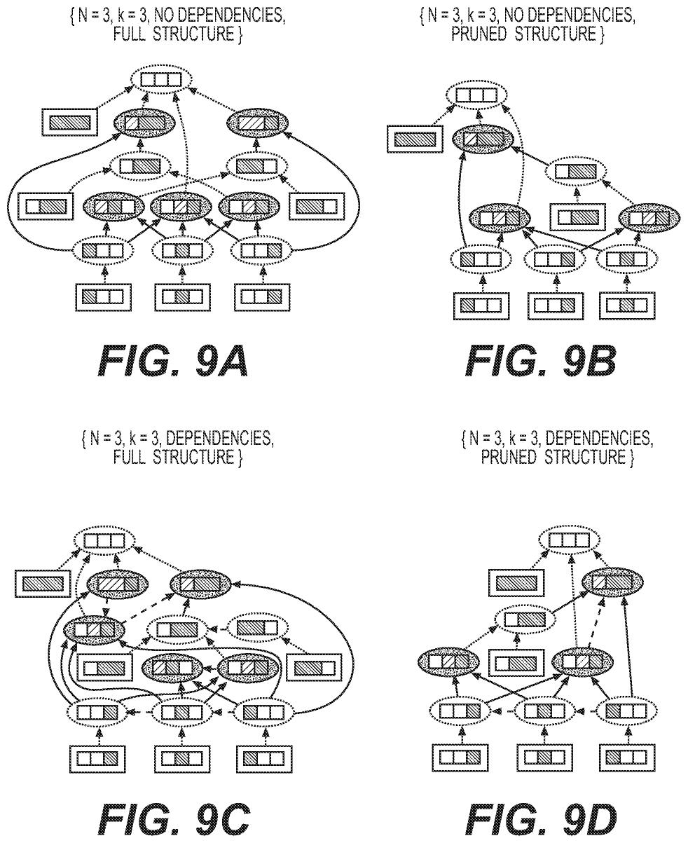

FIG. 9A shows an AOG building block generated from the algorithm of FIG. 4B configured with hyperparameters N=3, k=3, lateral connection=0, with pruned structure=0. FIG. 9B shows an AOG building block generated from the algorithm of FIG. 4B configured with hyperparameters N=3, k=3, lateral connection=0, with pruned structure=1. FIG. 9C shows an AOG building block generated from the algorithm of FIG. 4B configured with hyperparameters N=3, k=3, lateral connection=1, with pruned structure=0. FIG. 9D shows an AOG building block generated from the algorithm of FIG. 4B configured with hyperparameters N=3, k=3, lateral connection=1, with pruned structure=1.

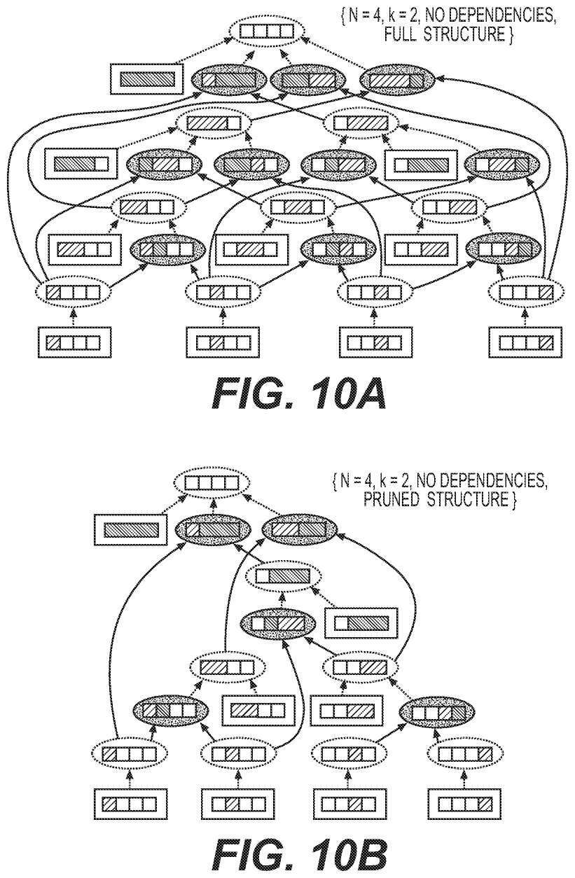

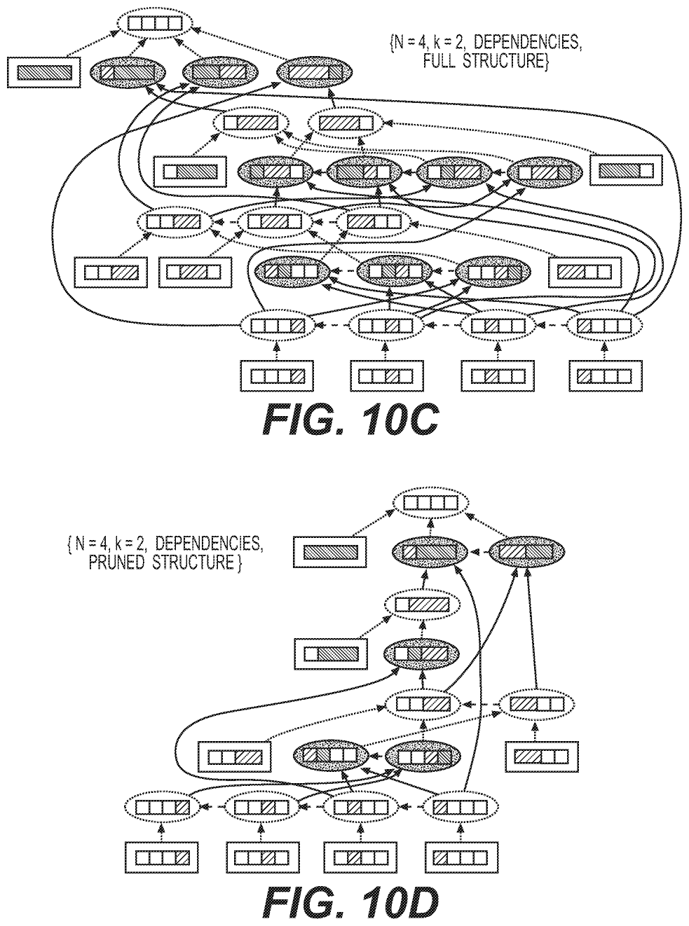

FIG. 10A shows an AOG building block generated from the algorithm of FIG. 4B configured with hyperparameters N=4, k=3, lateral connection=0, with pruned structure=0. FIG. 10B shows an AOG building block generated from the algorithm of FIG. 4B configured with hyperparameters N=4, k=3, lateral connection=0, with pruned structure=1. FIG. 10C shows an AOG building block generated from the algorithm of FIG. 4B configured with hyperparameters N=4, k=3, lateral connection=1, with pruned structure=0. FIG. 10D shows an AOG building block generated from the algorithm of FIG. 4B configured with hyperparameters N=4, k=4, lateral connection=1, with pruned structure=1.

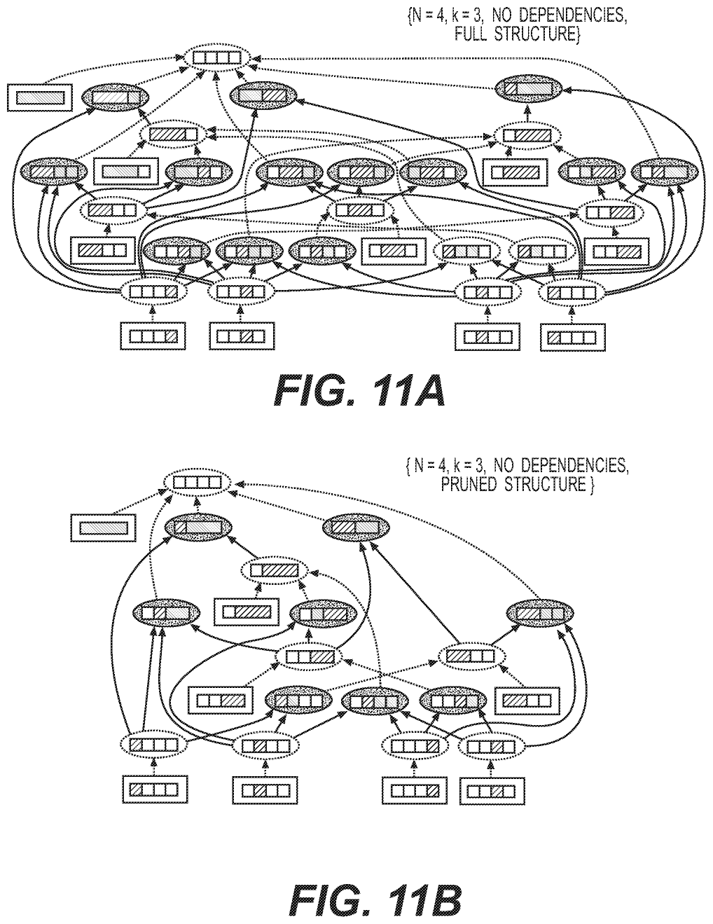

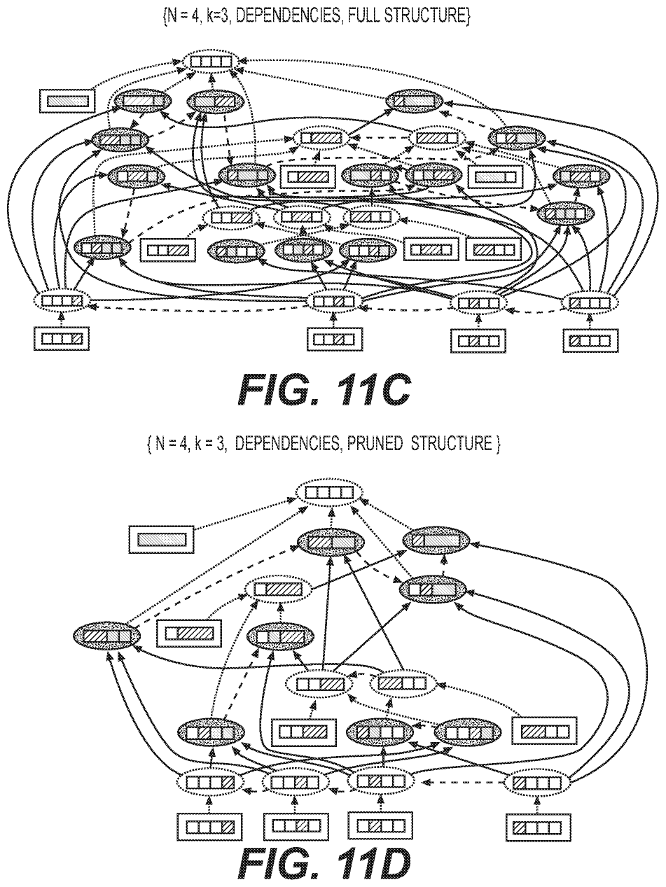

FIG. 11A shows an AOG building block generated from the algorithm of FIG. 4B configured with hyperparameters N=4, k=4, lateral connection=0, with pruned structure=0. FIG. 11B shows an AOG building block generated from the algorithm of FIG. 4B configured with hyperparameters N=4, k=4, lateral connection=0, with pruned structure=1. FIG. 11C shows an AOG building block generated from the algorithm of FIG. 4B configured with hyperparameters N=4, k=4, lateral connection=1, with pruned structure=0. FIG. 11D shows an AOG building block generated from the algorithm of FIG. 4B configured with hyperparameters N=4, k=4, lateral connection=1, with pruned structure=1.

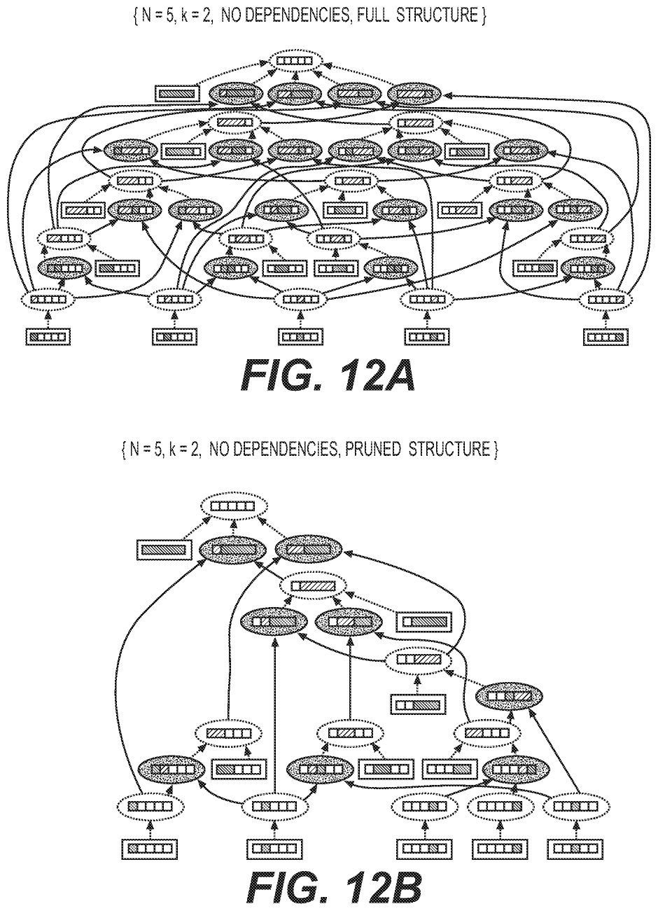

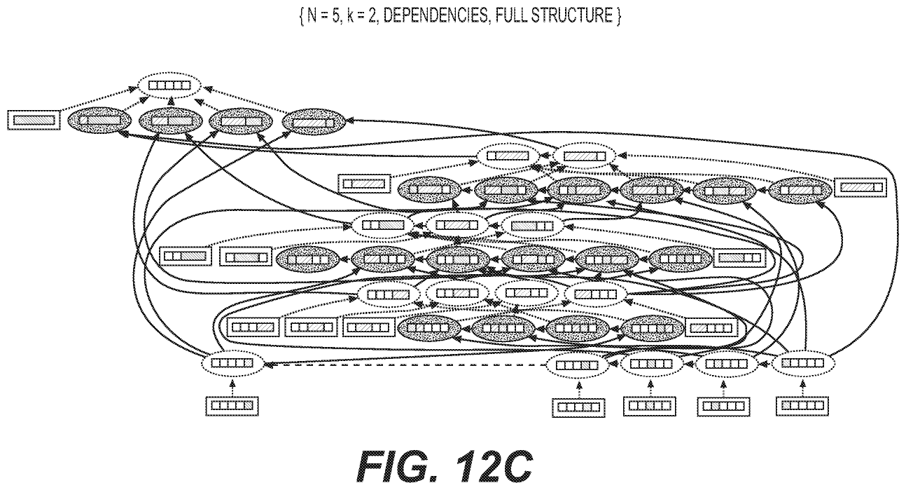

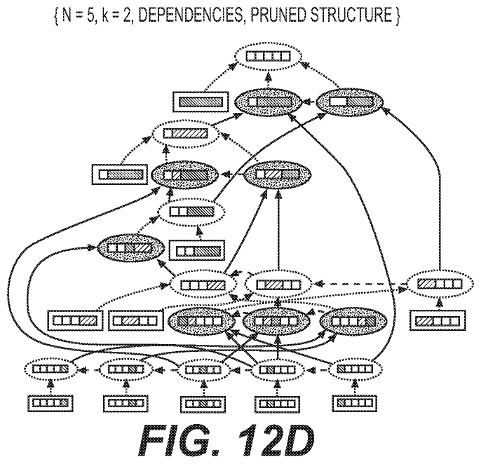

FIG. 12A shows an AOG building block generated from the algorithm of FIG. 4B configured with hyperparameters N=5, k=2, lateral connection=0, with pruned structure=0. FIG. 12B shows an AOG building block generated from the algorithm of FIG. 4B configured with hyperparameters N=5, k=2, lateral connection=0, with pruned structure=1. FIG. 12C shows an AOG building block generated from the algorithm of FIG. 4B configured with hyperparameters N=5, k=2, lateral connection=1, with pruned structure=0. FIG. 12D shows an AOG building block generated from the algorithm of FIG. 4B configured with hyperparameters N=5, k=2, lateral connection=1, with pruned structure=1.

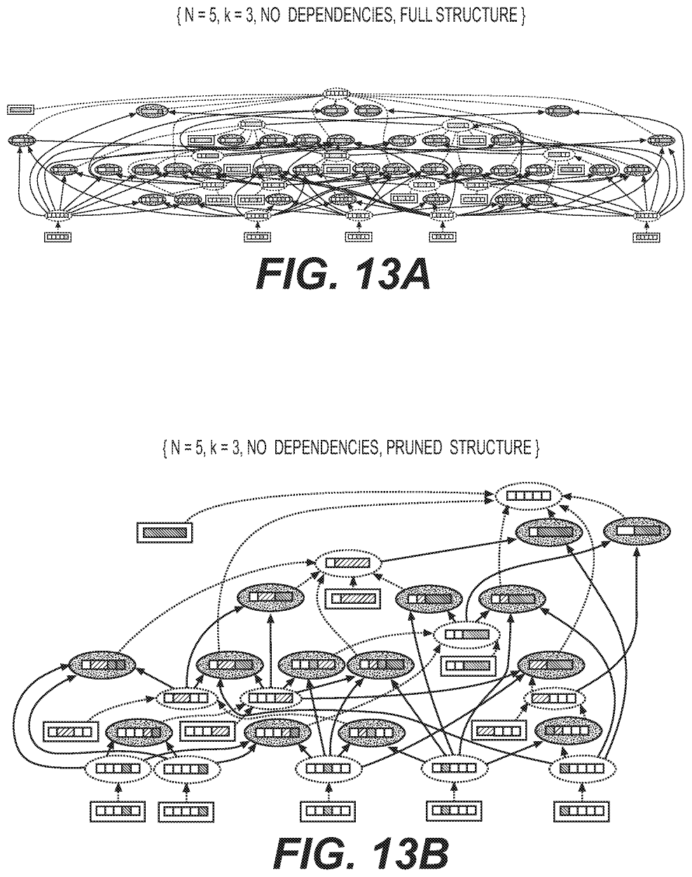

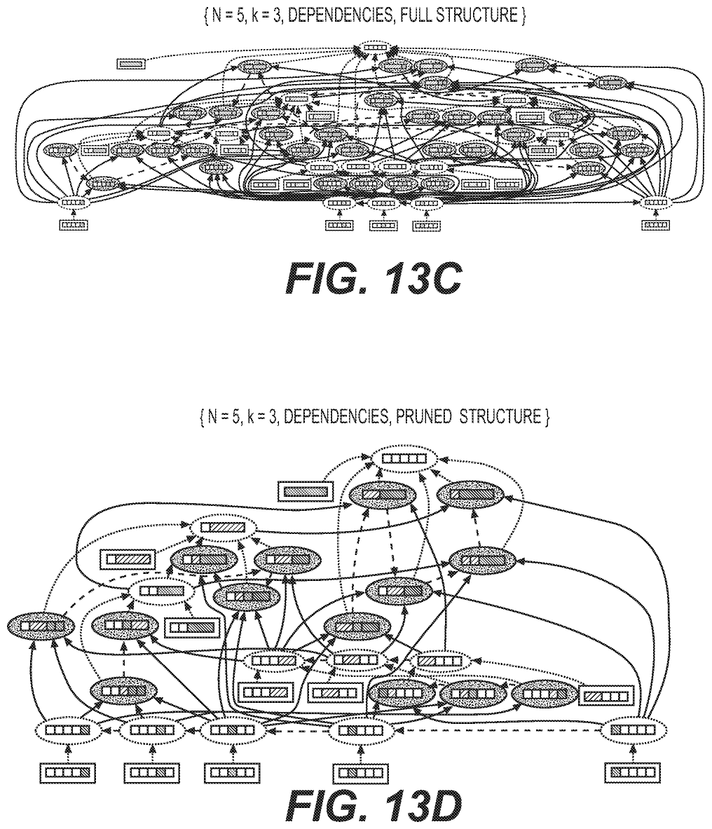

FIG. 13A shows an AOG building block generated from the algorithm of FIG. 4B configured with hyperparameters N=5, k=3, lateral connection=0, with pruned structure=0. FIG. 13B shows an AOG building block generated from the algorithm of FIG. 4B configured with hyperparameters N=5, k=3, lateral connection=0, with pruned structure=1. FIG. 13C shows an AOG building block generated from the algorithm of FIG. 4B configured with hyperparameters N=5, k=3, lateral connection=1, with pruned structure=0. FIG. 13D shows an AOG building block generated from the algorithm of FIG. 4B configured with hyperparameters N=5, k=3, lateral connection=1, with pruned structure=1.

The various embodiments of the AOG building block of FIGS. 7A-7B, 8A-8D, 9A-9D, 10A-10D, 11A-11D, 12A-12D, and 13A-13D, among others, can be instantiated in an AOG network based on two hyperparameters, including i) a number of stage, and ii) a number of AOG building block per stage. In other embodiments, the hyperparameter can include a AOG building block type for a given stage (i.e., each stage can have a different building block).

Compositional Stacking of AOG Building Block

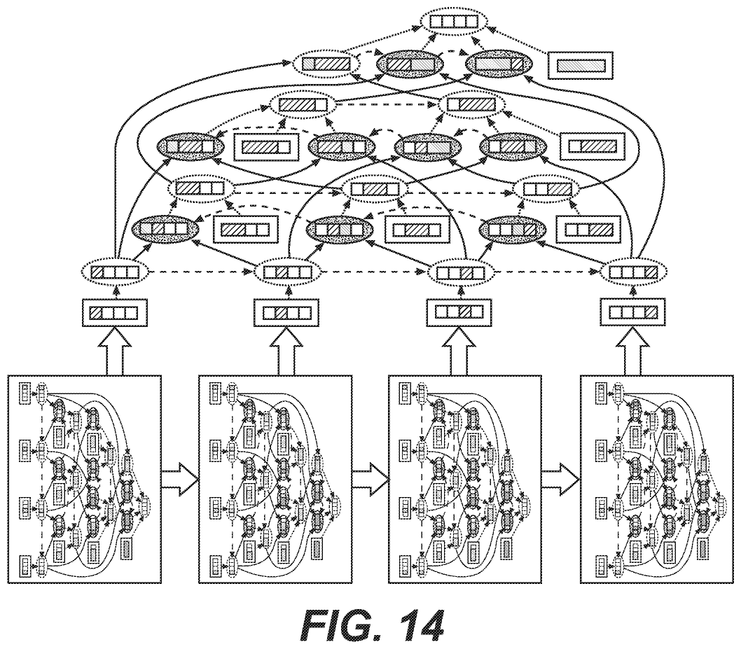

Similar to AOG building block having compositionally generated from AOG primitives, the AOG building block can itself be an AOG primitive. FIG. 14 shows a diagram of an AOG network in which a set of AOG building blocks are provided as word inputs to a later stage AOG building block (e.g., referred to as “AOGNet-in-AOGNet”), in accordance with an illustrative embodiment. The AOG building block are configured as a word that is provided as an input to another AOG building blocks stacked in the feedforward configuration. This process can be recursively applied to generate a third, fourth, fifth, etc, of AOG building blocks that are further stacked in feedforward configuration to lower level of AOG building blocks.

Recurrent AOGNet

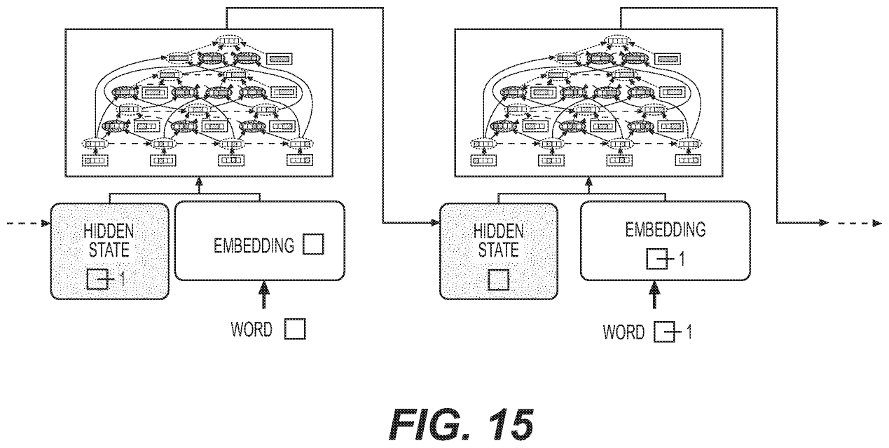

The AOGNet and AOG building blocks can be used to exploit language of 1-D grammar, which are naturally applicable to language modeling. FIG. 15 is a diagram of a compositional stacking AOG building block configuration as a recurrent AOGNet for natural language processing (NLP) tasks, where the AOG building blocks share parameters, and learn sub-word semantic relations that are important for machine translation and other language processing tasks. Though FIG. 15 shows two AOG building blocks of the same types, different AOG configurations as discussed herein can be used.

Design Methodology of Compositional Grammatical Neural Network

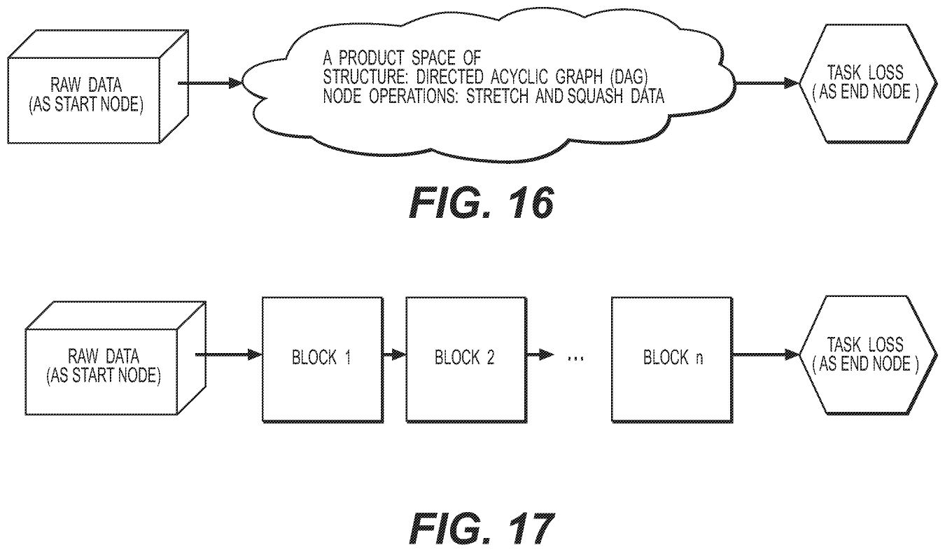

FIG. 16 is a diagram illustrating the design methodology of the compositional grammatical neural network node layers, in accordance with an illustrative embodiment. As shown in FIG. 16, network architecture design and search can be posed as a combinatorial search problem in a product space of two sub-spaces: a structure space and node operation space. The structure space includes all directed acyclic graphs (DAGs) with the start node representing input raw data and the end node representing task loss functions. DAGs are entailed for feasible computation in implementation. The node operation space which consists of all possible transformation functions for implementing nodes in a DAG, such as Convolution+BatchNorm+ReLU and its bottleneck implementation.

The structure space is almost unbounded, and the node operation space for a given structure is also combinatorial. Neural architecture design and search is an NP-hard problem due to the exponentially large space and the highly nonconvex non-linear objective function to be optimized in the search.

FIG. 17 is a diagram showing a building block based approaches to explore the structure space and node operation space of the compositional grammatical neural network node layers, in accordance with an illustrative embodiment. As shown in FIG. 17, to mitigate the difficulty, neural architecture design and search have been simplified to design or search a building block structure, and then stack the same build block structure into a predefined number of stages.

### EXPERIMENTAL RESULTS AND EXAMPLES

Implementation of AOGNets were tested on three highly competitive image classification benchmarks in a set of studies, including: the CIFAR-10, CIFAR-100 and ImageNet-1K benchmarks. From the first set of studies, it was observed that the tested AOGNets obtained better performance than ResNets and most of its variants, including DenseNets and DualPathNets. Also in the studies, AOGNets were also tested in object detection on PASCAL VOC 2007 and 2012 data sets using a vanilla Faster R-CNN system. It was also observed that the tested AOGNets obtained better performance than the ResNet backbone. In each of these studies, AOGNet was implemented using PyTorch.

Implementation: In the experiments, for node operations [symbol] O's, AOGNet was instantiated with either standard Conv-BatchNorm-ReLU or its bottleneck variant as described in K. He, X. Zhang, S. Ren, and J. Sun, “Deep residual learning for image recognition,” for all nodes. The study observed that when different operators can be applied for different types of nodes as long as the dimensionalities of matched during the computation.

In the experiments, after the AOG structure is specified, the number of parameters of an AOGNet was determined by the number of channels of input/output of each stage. Thus, for an M-stage AOGNet, an (M+1)-tuple was used to specify the number of channels. For example, the studies can specify the 4-tuple, (16; 16; 32; 64) or (16; 32; 64; 128) for a 3-stage AOGNet, resulting different number of parameters in total. The depth of an AOGNet was defined by the largest number of units which have learnable parameters along the paths from the final output to the input data following BFS order (e.g., a BN operator as shown in FIG. 6 is counted as 3 units).

In comparison, to indicate the specifications, AOGNets were written by AOGNet-[BN]-PrimitiveSize-(#AOG blocks per stage)-[OutputFeatDim]. For example, AOGNet-4-(1,1,1,1)-256d and AOGNet-BN-4-(1,1,1,1)-256d each represented a 4-stage AOGNet using standard node operator and bottleneck one respectively, both with primitive size being 4, 1 AOG building block per stage and the final output feature dimension is 256. In the case of models for ImageNet, the output feature dimension was fixed with 2048d without being written explicitly.

Experiments with CIFAR: CIFAR-10 and CIFAR-100 datasets as described in A. Krizhevsky and G. Hinton, “Learning multiple layers of features from tiny images,” Master's thesis, Department of Computer Science, University of Toronto, 2009, denoted by C10 and C100 respectively, consist of 32×32 color images drawn from 10 and 100 classes. The training and test sets contains 50,000 and 10,000 images respectively. The studies adopt widely-used standard data augmentation scheme, random cropping and mirroring, in preparing the training data.

The studies trained AOGNets with stochastic gradient descent (SGD) for 300 epochs with parameters initialized by the Xavier method as described in X. Glorot and Y. Bengio, “Understanding the difficulty of training deep feedforward neural networks,” In Proceedings of the Thirteenth International Conference on Artificial Intelligence and Statistics, AISTATS 2010, Chia Laguna Resort, Sardinia, Italy, May 13-15, 2010, pages 249-256, 2010. The initial learning rate is set to 0.1 and is divided by 10 at 150 and 225 epoch, respectively.

For CIFAR-10, the studies chose a batch size 64 with a weight decay 1×10⁻⁴, while a batch size 128 with weight decay 5×10⁻⁴ was adopted for CIFAR-100. The momentum was set to 0.9. If the network used only Conv-BatchNorm-ReLU (without bottleneck), a dropout layer of dropout ratio 0.1 was applied after each Conv-BatchNorm-ReLU block.

Results and Analyses. Results are summarized in Table 2. Specifically, Table 2 shows error rates (%) on the two CIFAR datasets while #Params uses the unit of Million, and k in DenseNet refers to the growth rate.

With smaller model complexity and much reduced computing complexity (FLOPs), the studies observed that AOGNets consistently obtained better performance than ResNets and some of the variants, ResNeXts and DenseNets on both datasets.

TABLE 2

| Method | Depth | #Params | FLOPs | | C10 | C100 |
|---|---|---|---|---|---|---|
| ResNet | 110 | 1.7M | 0.251 | G | 6.61 | — |
| ResNet | 110 | 1.7M | 0.251 | G | 6.41 | 27.22 |
| ResNet (pre-activation) | 164 | 1.7M | 0.251 | G | 5.46 | 24.33 |
| | 1001 | 10.2M | | | 4.62 | 22.71 |
| Wide ResNet | 16 | 11.0M | | | 4.81 | 22.07 |
| | 28 | 36.5M | 5.24 | G | 4.17 | 20.50 |
| FractalNet | 21 | 38.6M | | | 5.22 | 23.30 |
| with Dropout/DropPath | 21 | 38.6M | | | 4.60 | 23.73 |
| ResNeXt-29, 8 × 64 d | 29 | 34.4M | 3.01 | G | 3.65 | 17.77 |
| ResNeXt-29, 10 × 64 d | 29 | 68.1M | 5.59 | G | 3.58 | 17.31 |
| DenseNet-BC (k = 12) | 100 | 0.8M | 0.292 | G | 4.51 | 22.27 |
| DenscNet-BC (k = 24) | 250 | 15.3M | 5.46 | G | 3.62 | 17.60 |
| DenseNet-BC (k = 40) | 190 | 25.6M | 9.35 | G | 3.46 | 17.18 |
| AOGNet-BN-4-(1, 1, 1) | 65 | 0.785M | 0.123 | G | 4.38 | 21.26 |
| AOGNet-BN-4-(1, 2, 1) | 86 | 16.4M | 2.53 | G | 3.27 | 16.63 |

Experiments on ImageNet1K: The ILSVRC 2012 classification dataset consists of about 1.2 million images for training, and 50,000 for validation, from 1,000 classes. The studies adopted a data augmentation scheme for training images as done in K. He, X. Zhang, S. Ren, and J. Sun, “Deep residual learning for image recognition,” In IEEE Conference on Computer Vision and Pattern Recognition (CVPR), 2016, which is incorporated by reference herein in its entirety, and applied a single-crop with size 224×224 at test time. Following the common protocol, the studies evaluated the top-1 and top-5 classification error rates on the validation set.

The studies used AOGNet-BN with four stages for training the ImageNet-1K data set. Before entering the first AOG stage, a 7×7 convolution layer with stride 2 and filter size 64 was performed on the input image and is followed by a 3×3 max pooling layer with stride 2. Similar to the network structure for training CIFAR, in the first AOG block of each stage s (s≥2), the convolution operation of all the terminal nodes in that block was performed with a stride 2. The intermediate and output feature map sizes in the four stages are 56×56, 28×28, 14×14 and 7×7. The output channel width of each four stages was set as 256; 512; 1024 and 2048.

The studies trained the AOGNet with stochastic gradient descent (SGD) for 120 epochs with parameters initialized by the Xavier method. The initial learning rate was set to 0:1 and was divided by 10 at 30; 60 and 90 epoch, respectively. The studies also set the batch size to 256 with a weight decay 1×10⁻⁴ and a momentum 0:9.

Results and Analyses. Results and comparisons are shown in Table 3. Specifically, Table 3 shows the top-1 and top-5 error rates (%) on the ImageNet-1K validation set using single model and single-crop testing. Similar to the results on CIFAR (Table 2), with smaller model complexity and reduced computing complexity, the tested AOGNets outperformed ResNets, ResNeXts, DenseNets and DualPathNets.

TABLE 3

| Method | #Params | FLOPS | | top-1 | top-5 |
|---|---|---|---|---|---|
| ResNet-101 | 44.5M | 8 | G | 23.6 | 7.1 |
| ResNet-152 | 60.2M | 11 | G | 23.0 | 6.7 |
| ResNeXt-50 | 25.03M | 4.1 | G | 22.6 | 6.29 |
| DensetNet-169 | 13.5M | 4 | G | 23.8 | 6.85 |
| DualPathNet-68 | 12.8M | 2.5 | G | 23.57 | 6.93 |
| AOGNet-BN-4-(1, 2, 1) | 11.97M | 2.19 | G | 22.6 | 6.2 |

Object Detection on PASCAL VOC: The study also tested AOGNets in object detection on the PASCAL VOC 2007 and 2012 datasets. The study adopted the vanilla Faster RCNN system and reused the code in MXNet. The study substituted the ConvNet backbone with the AOGNets in experiments and kept everything else unchanged for comparison. The study used the 4-stage AOGNet-BN-4-(1,1,1,1) pretrained on ImageNet. The study adopted the end-to-end training procedure implemented in MXNet to train the region proposal network (RPN) and RCNN jointly. The first three stages are shared by RPN and RCNN, and the last stage is used as the head classifier for region-of-interest (RoI) prediction. The study fixed all parameters pretrained on ImageNet before stage 1 (inclusive) in training. The study followed standard evaluation metrics Average Precision (AP) and mean of AP (mAP) in the PASCAL challenge protocols for evaluation.

Results and Analyses. Table 4 shows the detection results and comparisons. As shown, the AOGNets obtain better mAP than ResNet-101 by more than 2% consistently. Specifically, Table 4 shows performance comparisons using Average Precision (AP) at the intersection over union (IoU) threshold 0.5 (AP@0.5) in the PASCAL VOC2007/VOC2012 dataset (using the protocol, competition “comp4” trained with ImageNet pretrained models and using only 2007 trainval or both 2007 and 2012 trainval datasets). * reported based on our re-implementation for fair comparisons. The results evaluated by the VOC2012 test server can be viewed at http://host.robots.ox.ac.uk:8080/anonymous/XHO7OS.html (AOGNet-BN-4-(1,1,1,1)) and http://host.robots.ox.ac.uk:8080/anonymous/XMV4AI.html (ResNet-101).

TABLE 4

| | Method | mAP | areo | bike | bird | boat | bottle | bus | car | cat | chair | cow |
|---|---|---|---|---|---|---|---|---|---|---|---|---|
| 07trainval/07test | ResNet-101* | 74.7 | 75.8 | 81.6 | 75.0 | 67.4 | 60.1 | 81.4 | 85.6 | 84.7 | 59.7 | 79.7 |
| | AOGNet-BN-4-(1, 1, 1, 1) | 77.6 | 78.8 | 83.4 | 79.3 | 66.1 | 65.2 | 85.9 | 87.4 | 87.3 | 62.6 | 86.2 |
| 07 + | ResNet-101 | 76.4 | 79.8 | 80.7 | 76.2 | 68.3 | 55.9 | 85.1 | 85.3 | 89.8 | 56.7 | 87.8 |
| 12trainval/07test | ResNet-101* | 78.4 | 79.0 | 81.9 | 78.6 | 69.1 | 66.4 | 85.5 | 87.9 | 88.5 | 65.0 | 84.4 |
| | AOGNet-BN-4-(1, 1, 1, 1) | 81.2 | 79.1 | 86.5 | 81.4 | 73.4 | 70.5 | 87.4 | 88.9 | 88.8 | 68.4 | 87.0 |
| 07 + | ResNet-101* | 75.1 | 87.2 | 83.1 | 74.5 | 60.1 | 58.3 | 80.3 | 80.1 | 90.8 | 57.5 | 79.4 |
| 12trainval/07test | AOGNet-BN-4-(1, 1, 1, 1) | 77.9 | 88.6 | 85.7 | 79.4 | 66.6 | 63.2 | 83.6 | 82.2 | 92.4 | 59.0 | 80.6 |

| | Method | mAP | table | dog | horse | mbike | person | plant | sheep | sofa | train | tv |
|---|---|---|---|---|---|---|---|---|---|---|---|---|
| 07trainval/07test | ResNet-101* | 74.7 | 69.4 | 84.4 | 83.8 | 79.3 | 79.1 | 47.6 | 73.7 | 74.1 | 77.9 | 74.6 |
| | AOGNet-BN-4-(1, 1, 1, 1) | 77.6 | 70.0 | 87.6 | 87.2 | 81.6 | 79.5 | 51.7 | 77.7 | 78.0 | 80.7 | 75.9 |
| 07 + | ResNet-101 | 76.4 | 69.4 | 88.3 | 88.9 | 80.9 | 78.4 | 41.7 | 78.6 | 79.8 | 85.3 | 72.0 |
| 12trainval/07test | ResNet-101* | 78.4 | 73.6 | 85.6 | 87.2 | 84.3 | 79.7 | 50.9 | 77.6 | 80.1 | 85.3 | 77.8 |
| | AOGNet-BN-4-(1, 1, 1, 1) | 81.2 | 77.4 | 88.3 | 89.3 | 85.1 | 83.5 | 55.6 | 83.8 | 82.2 | 86.1 | 81.2 |
| 07 + | ResNet-101* | 75.1 | 60.7 | 88.7 | 84.2 | 84.1 | 82.6 | 52.5 | 76.9 | 67.4 | 84.4 | 68.3 |
| 12trainval/07test | AOGNet-BN-4-(1, 1, 1, 1) | 77.9 | 62.7 | 90.4 | 88.0 | 85.7 | 84.7 | 57.6 | 79.7 | 70.0 | 87.2 | 71.8 |

### ADDITIONAL EXPERIMENTAL RESULTS AND EXAMPLES

The instant AOGNet was further tested, in addition to the CIFAR-10 and CIFAR-100 [32], and ImageNet-1K [52] classification benchmark, in a second set of studies along with the MS-COCO object detection and segmentation benchmark. The MS-COCO benchmark is described in Tsung-Yi Lin et al, “Microsoft COCO: common objects in context,” CoRR, abs/1405.0312, 2014, which is incorporated by reference herein in its entirety.

Implementation Settings and Details. The second set of studies also used simplified AOG building blocks. For the node operation [symbol] ( ), the studies used the bottleneck variant of Conv-BNReLU proposed in Kaiming He et al., “Deep residual learning for image recognition,” In IEEE Conference on Computer Vision and Pattern Recognition (CVPR), 2016, which is incorporated by reference herein. The structure added one 1×1 convolution before and after the operation to first reduce feature dimensions and then to expand it back. More specifically, [symbol] (x)=ReLU(x+T(x)) was set for an input feature map X, where [symbol] ( ) represents a sequence of primitive operations: Conv1×1-BN-ReLU, Conv3×3-BN-ReLU, and Conv1×1-BN. When dropout was used with drop rate p∈(0, 1), the drop rate was added after the last BN, i.e., [symbol] (x)=ReLU(x+Dropout(T(x); p)).

Handling double-counting due to the compositional DAG structure and lateral connections. In this set of studies, some nodes of the AOG building blocks are configured to have multiple paths to reach the root OR-node due to the compositional DAG structure. Since skip connection were used in the node operation [symbol] ( ), the feature maps of those nodes with multiple paths were double-counted at the root OR-node. Additionally, if a node v and its lateral node vₗₐₜₑᵣₐₗ shared a parent node, double-counting in the skip connection were handled. The number of paths between v and the root OR-node, denoted by n(v), can be counted during the building block construction (see, e.g., Algorithm 1). For example, for an AND-node A with two syntactic child node L and R and the lateral node Aₗₐₜₑᵣₐₗ, the studies computed two different inputs, one for the skip connection (see Equation 10) and the other for T( ).

$$\begin{matrix} {f}_{in}^{skip} ( A ) = [ {f}_{out} ( L ) \cdot \frac{n ( A )}{n ( L )} , {f}_{out} ( R ) \cdot \frac{n ( A )}{n ( R )} ] \\ if A and {A}_{lateral} share a parent node ; \\ {f}_{in}^{skip} ( A ) = [ {f}_{out} ( L ) \cdot \frac{n ( A )}{n ( L )} , {f}_{out} ( R ) \cdot \frac{n ( A )}{n ( R )} ] + {f}_{out} ( {A}_{lateral} ) \cdot \frac{n ( A )}{n ( {A}_{lateτal} )} , otherwise & ( Equation 10 ) \\ T ( ) , {f}_{in}^{T} ( A ) = [ {f}_{out} ( L ) , {f}_{out} ( R ) ] + {f}_{out} ( {A}_{lateral} ) & ( Equation 11 )\end{matrix}$$

The transformation for node A were then implemented by [symbol] (A)=ReLU(f^{skip}(A)+T(fᵢₙ^{T}(A))). It should be appreciated that λᵤ's in the OR-node operation can be set and/or λ's can also be treated as unknown parameters to be learned end-to-end.

Image Classification in ImageNet-1K. The ILSVRC 2012 classification dataset consists of about 1:2 million images for training, and 50,000 for validation, from 1,000 classes. The same data augmentation scheme (random crop and horizontal flip) were adopted for training images and a single-crop with size 224×224 was applied at test time. Following the common protocol, the top-1 and top-5 classification error rates were evaluated on the validation set.

Table 5 shows the top-1 and top-5 error rates (%) on the ImageNet-1K validation set using single model and single-crop testing.

TABLE 5

| Method | #Params | FLOPS | | top-1 | top-5 |
|---|---|---|---|---|---|
| ResNet-101 | 44.5M | 8 | G | 23.6 | 7.1 |
| ResNet-152 | 60.2M | 11 | G | 23.0 | 6.7 |
| ResNeXt-50 | 25.03M | 4.2 | G | 22.2 | 5.6 |
| ResNeXt-101 (32 × 4 d) | 44M | 8.0 | G | 21.2 | 5.6 |
| ResNeXt-101 (64 × 4 d) | 83.9M | 16.0 | G | 20.4 | 5.3 |
| ResNeXt-101 + BAM | 44.6M | 8.05 | G | 20.67 | — |
| ResNeXt-101 + CBAM | 49.2M | 8.0 | G | 20.60 | — |
| ResNeXt-50 + SE | 27.7M | 4.3 | G | 21.1 | 5.49 |
| ResNeXt-101 + SE | 48.9M | 8.46 | G | 20.58 | 5.01 |
| DensetNet-161 | 27.9M | 7.7 | G | 22.2 | — |
| DensetNet-169 | ~13.5M | ~4 | G | 23.8 | 6.85 |
| DensetNet-264 | ~33.4M | — | | 22.2 | 6.1 |
| DensetNet-cosine-264 | ~73M | ~26 | G | 20.4 | — |
| DPN-68 | 12.8M | 2.5 | G | 23.57 | 6.93 |
| DPN-92 | 38.0M | 6.5 | G | 20.73 | 5.37 |
| DPN-98 | 61.6M | 11.7 | G | 20.15 | 5.15 |
| AOGNet-12M | 11.9M | 2.36 | G | 22.28 | 6.14 |
| AOGNet-40M | 40.3M | 8.86 | G | 19.82 | 4.88 |
| AOGNet-60M | 60.7M | 14.36 | G | 19.34 | 4.78 |

Model specifications. The studies tested three AOGNets with different model complexities. In comparison, the studies used the model size as the name tag for AOGNets (e.g., AOGNet-12M means the AOGNet has 12 million parameters or so). The stem (see FIG. 5) used three Conv3×3-BN layers (with stride 2 for the first layer), followed by a 2×2 max pooling layer with stride 2. All the three AOGNets used four stages. Within a stage, the studies used the same AOG building block, while different stages may use different blocks. A stage was then specified by Nₙ where N is primitive size (see, e.g., Algorithm 1) and n the number of blocks. The filter channels were defined by a 5-tuple for specifying the input and output dimensions for the 4 stages. The detailed specifications of the three AOGNets were as follows: AOGNet-12M used stages of (2₂, 4₁, 4₃, 2₁) with filter channels (32, 128, 256, 512, 936); AOGNet-40M used stages of (2₂, 4₁, 4₄, 2₁) with filter channels (60, 240, 448, 968, 1440); AOGNet-60M used stages of (2₂, 4₂, 4₅, 2₁) withe filter channels (64, 256, 512, 1160, 1400).

Training settings. The studies adopted random parameter initialization for filter weights. For Batch Normalization (BN) layers, the studies used “0” to initialize all offset parameters. The studies used “1” to initialize all scale parameters except for the last BN layer in each [symbol] ( ) where the scale parameter was initiated by “0.” Further description of the initialization may be found in Priya Goyal et al., “Accurate, large minibatch SGD: training imagenet in 1 hour,” CoRR, abs/1706.02677, 2017. The studies used dropout with drop rate 0.1 in the last two stages. The studies used 8 GPUs (NVIDIA V100) in the training stage. The batch size was 128 per GPU (1024 in total). The initial learning rate was set as 0.4, and a cosine learning rate scheduler, e.g., as described in Ilya Loshchilov et al., “SGDR: stochastic gradient descent with restarts,” CoRR, abs/1608.03983, 2016, was used with weight decay 1×10⁻⁴ and a momentum 0.9. The studies trained AOGNet with SGD for 120 epochs in which 5 epochs were used for linear warm-up following.

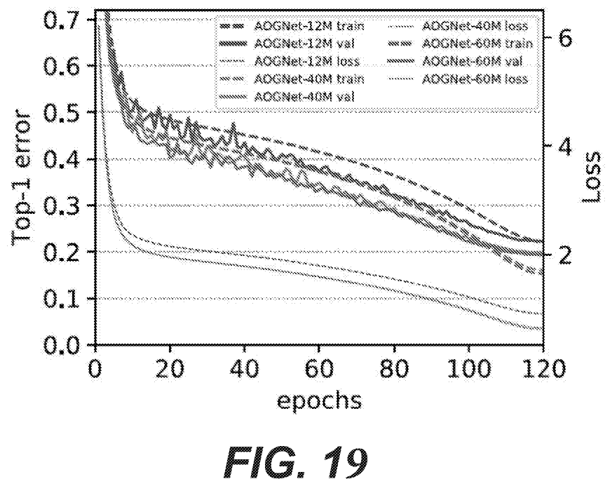

Results and Analyses. From the studies, it was observed that AOGNets obtained the best accuracy and model interpretability, which are shown in Table 5. FIG. 19 shows plots for the top-1 error rates and training losses of the three AOGNets in ImageNet.

Indeed, it was observed that AOGNets performed the best among the models with comparable model sizes with respect to top-1 and top-5 accuracy. It was also observed that the smaller AOGNet-12M outperformed the ResNets system having 44.5M and 60.2M parameters, having greater top-1 and top-5 accuracy by 1.32% and 0.72%, respectively.

The studied AOGNets used the same bottleneck operation function as ResNets, so the improvement may be contributed to the AOG building block structure. The studied AOGNet-40M obtained better performance than all other methods in comparison, including ResNeXt-101 and ResNeXt-101+SE (configured with 48.9M params), which represented the most powerful and widely used combination in practice). The studied AOGNet-40M also obtained better performance than DPN-98 (configured with 61.6M params), which indicates that the hierarchical and compositional integration of the DenseNet- and ResNet-aggregation in the studied AOG building block was more effective than the cascade-based integration in the DPN.

The studied AOGNet-60M was observed to achieve the best results. The FLOPs of the AOGNet-60M were slightly higher than DPN-98. This may be attributed the DPN use of ResNeXt operation (i.e., group conv.). In the on-going experiments, AOGNets are tested with ResNeXt node operations.

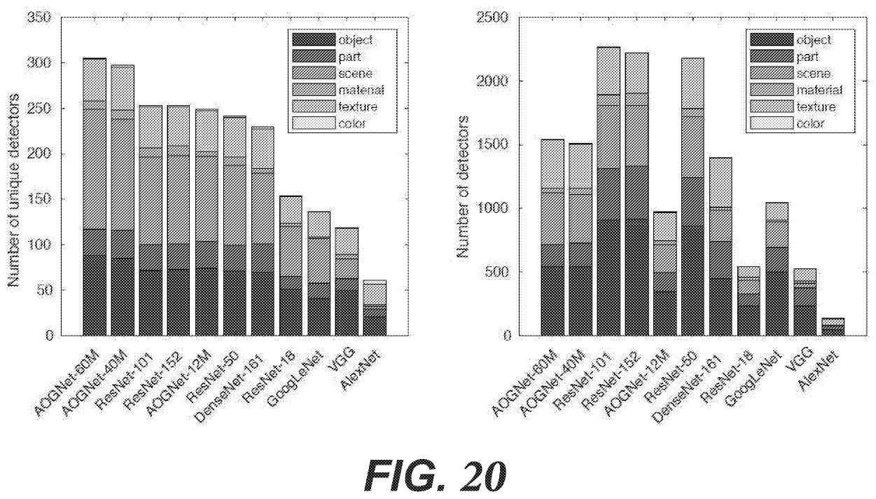

Model Interpretability. Model Interpretability has been recognized as a critical concern in developing deep-learning-based AI systems. The network dissection metric was used in the number of unique “detectors” (i.e., filter kernels) were compared in the last convolution layer. FIG. 20 shows a comparisons of model interpretability using the network dissection method on ImageNet pretrained networks. The dissection method is described in David Bau et al., “Network dissection: Quantifying interpretability of deep visual representations,” In Proceedings of the IEEE Conference on Computer Vision and Pattern Recognition, 2017.

Per, FIG. 20, it can be observed that AOGNet obtained the best score indicating the AOG building block has great potential to induce model interpretability by design, while achieving the best accuracy performance.

Adversarial robustness. Adversarial robustness was another issue faced by many DNNs. The studies conducted an experiment to compare the out-of-the-box adversarial robustness of different DNNs; the results are in Table 6.

Table 6 shows experimental results of the top-1 accuracy comparisons under white-box adversarial attack using 1-step FGSM with the Foolbox toolkit. Description of FGSM may be found at Ian Goodfellow et al., “Explaining and harnessing adversarial examples,” In ICLR, 2015, and description of the Foolbox toolkit may be found at Jonas Rauber et al, “Foolbox: A python toolbox to benchmark the robustness of machine learning models,” arXiv preprint arXiv:1707.04131, 2017.

TABLE 6

| Method | #Params | ∈ = 0.1 | ∈ = 0\|.3 | clean |
|---|---|---|---|---|
| ResNet-101 | 44.5M | 12.3 | 0.40 | 77.37 |
| ResNet-152 | 60.2M | 16.3 | 0.85 | 78.31 |
| DenseNet-161 | 28.7M | 13.0 | 2.1 | 77.65 |
| AOGNet-12M | 12.0M | 18.1 | 1.4 | 77.72 |
| AOGNet-40M | 40.3M | 28.3 | 2.2 | 80.18 |
| AOGNet-60M | 60.1M | 30.2 | 2.6 | 80.66 |

Under the vanilla settings, the studied AOGNets showed better potential in adversarial defense, especially when the perturbation energy is controlled relatively low (e.g., ∈=0.1). AOGNets may be trained with adversarial attacks to safeguard against various attacks.

Mobile settings. The studies also assessed mobile settings of AOGNets. An AOGNet-4M was trained under a typical mobile settings, e.g., as described in Andrew G Howard et al., “Mobilenets: Efficient convolutional neural networks for mobile vision applications,” arXiv preprint arXiv:1704.04861, 2017. 8. Table 7 shows the comparison results. Specifically, Table 7 shows the top-1 and top-5 error rates (%) based on the ImageNet-1K validation set under mobile settings.

TABLE 7

| Method | #Params | FLOPS | top-1 | top-5 |
|---|---|---|---|---|
| MobileNetV1 | 4.2M | 575M | 29.4 | 10.5 |
| SqueezeNext | 4.4M | — | 30.92 | 10.6 |
| ShuffleNet (1.5) | 3.4M | 292M | 28.5 | — |
| ShuffleNet (x2) | 5.4M | 524M | 26.3 | — |
| CondenseNet (G = C = 4) | 4.8M | 529M | 26.2 | 8.3 |
| MobileNetV2 | 3.4M | 300M | 28.0 | 9.0 |
| MobileNetV2 (1.4) | 6.9M | 585M | 25.3 | 7.5 |
| NASNet-C (N = 3) | 4.9M | 558M | 27.5 | 9.0 |
| AOGNet-4M | 4.2M | 557M | 26.2 | 8.24 |

The studied AOGNet obtained performance on par to the popular networks specifically designed for e-mobile platforms such as the MobileNets and ShuffleNets. The studied AOGNet also outperformed the auto-searched network, NASNet (which used around 800 GPUs in search). In the study, the same AOGNet structure was used, which showed device-agnostic capability of the AOGNets. Indeed, AOGNet DNNs may be deployed to different platforms with no extra efforts of hand-crafting or searching neural architectures are entailed. in some embodiments, small models may be distilled from a large model if they share the exactly same structure.

Object Detection and Segmentation in COCO. MS-COCO is one of the most widely used benchmarks for object detection and segmentation. It consists of 80 object categories. The studies trained AOGNet in the COCO train2017 set and evaluate in the COCO val2017 set. The studies reported the standard COCO metrics of Average Precision (AP), AP50, and AP75, for bounding box detection (APbb) and instance segmentation, i.e. mask prediction (APm). The studies experimented on the Mask-RCNN system, e.g., as described in Kaiming He et al., “Mask R-CNN,” In IEEE International Conference on Computer Vision, ICCV 2017, Venice, Italy, Oct. 22-29, 2017, pages 2980-2988, 2017, using the state-of-the-art implementation, maskrcnn-benchmark [45]. The studies used AOGNets pretrained on ImageNet-1K as the backbones. In fine-tuning for object detection and segmentation, the studies froze all the BN parameters as done for the ResNet and ResNeXt backbones and kept all remaining aspects unchanged. The studies tested both the C4 and FPN settings.

Results. Table 8 shows Mask-RCNN results on coco val2017 data set using the 1× training schedule. Results of ResNets and ResNeXts were reported by the maskrcnn-benchmark.

TABLE 8

| Method | #Params | t (s/img) | AP^{bb} | AP₅₀^{bb} | AP₇₅^{bb} | AP^{m} | AP₅₀^{m} | AP₇₅^{m} |
|---|---|---|---|---|---|---|---|---|
| ResNet-50-C4 | 35.9M | 0.130 | 35.6 | 56.1 | 38.3 | 31.5 | 52.7 | 33.4 |
| ResNet-101-C4 | 54.9M | 0.180 | 39.2 | 59.3 | 42.2 | 33.8 | 55.6 | 36.0 |
| AOGNet-12M-C4 | 14.6M | 0.092 | 36.8 | 56.3 | 39.8 | 32.0 | 52.9 | 33.7 |
| AOGNet-40M-C4 | 48.1M | 0.184 | 41.4 | 61.4 | 45.2 | 35.5 | 57.8 | 37.7 |
| ResNet-50-FPN | 44.3M | 0.125 | 37.8 | 59.2 | 41.1 | 34.2 | 56.0 | 36.3 |
| ResNet-101-FPN | 63.3M | 0.145 | 40.1 | 61.7 | 44.0 | 36.1 | 58.1 | 38.3 |
| ResNeXt-101-FPN | 107.4M | 0.202 | 42.2 | 63.9 | 46.1 | 37.8 | 60.5 | 40.2 |
| AOGNet-12M-FPN | 31.2M | 0.122 | 38.0 | 59.8 | 41.3 | 34.6 | 56.6 | 36.4 |
| AOGNet-40M-FPN | 59.4M | 0.147 | 41.8 | 63.9 | 45.7 | 37.6 | 60.3 | 40.1 |
| AOGNet-60M-FPN | 78.9M | 0.171 | 42.5 | 64.4 | 46.7 | 37.9 | 60.9 | 40.3 |

As shown in Table 8, the studied AOGNets obtained better results than the ResNet and ResNeXt backbones while also using a smaller model size, and doing so, using similar or slightly better inference time. The results show the effectiveness of the instant AOGNets in having better learning features for object detection and segmentation tasks.

Experiments on CIFAR. CIFAR-10 and CIFAR-100 datasets, denoted by C10 and C100, respectively, were also conducted. These data set consists of 32×32 color images drawn from 10 and 100 classes. The training and test sets contained 50,000 and 10,000 images, respectively. The studies adopted widely used standard data augmentation scheme, random cropping and mirroring, in preparation of the training data. The studies trained AOGNets with stochastic gradient descent (SGD) for 300 epochs with random parameter initialization. The front-end (see FIG. 6) used a single convolution layer. The initial learning rate was set to 0.1 and was divided by 10 at 150 and 225 epoch, respectively. For CIFAR-10, the studies chose a batch size 64 with weight decay 1×10⁻⁴, while batch size 128 with weight decay 5×10⁴ was adopted for CIFAR-100. The momentum was set to 0.9.

Results and Analyses. Table 9 shows error rates (%) on the two CIFAR datasets. #Params are shown in unit of millions, and k in DenseNet refers to the growth rate.

TABLE 9

| Method | Depth | #Params | FLOPs | | C10 | C100 |
|---|---|---|---|---|---|---|
| ResNet | 110 | 1.7M | 0.251 | G | 6.61 | — |
| ResNet | 110 | 1.7M | 0.251 | G | 6.41 | 27.22 |
| ResNet (pre-activation) | 164 | 1.7M | 0.251 | G | 5.46 | 24.33 |
| | 1001 | 10.2M | — | | 4.62 | 22.71 |
| Wide ResNet | 16 | 11.0M | — | | 4.81 | 22.07 |
| DenseNet-BC (k = 12) | 100 | 0.8M | 0.292 | G | 4.51 | 22.27 |
| AOGNet-1M | — | 0.78M | 0.123 | G | 4.37 | 20.95 |
| DenseNet-BC (k = 24) | 250 | 15.3M | 5.46 | G | 3.62 | 17.60 |
| AOGNet-16M | — | 15.8M | 2.4 | G | 3.42 | 16.93 |
| Wide ResNet | 28 | 36.5M | 5.24 | G | 4.17 | 20.50 |
| FractalNet | 21 | 38.6M | — | | 5.22 | 23.30 |
| with Dropout/DropPath | 21 | 38.6M | — | | 4.60 | 23.73 |
| ResNeXt-29, 8 × 64 d | 29 | 34.4M | 3.01 | G | 3.65 | 17.77 |
| ResNeXt-29, 16 × 64 d | 29 | 68.1M | 5.59 | G | 3.58 | 17.31 |
| DenseNet-BC (k = 40) | 190 | 25.6M | 9.35 | G | 3.46 | 17.18 |
| AOGNet-25M | — | 24.8M | 3.7 | G | 3.27 | 16.63 |

With smaller model sizes and much reduced computing complexity (FLOPs), the studied AOGNets consistently obtained better performance on both datasets than ResNets and some of the variants, ResNeXts, and DenseNets. The studied small AOGNet (0.78M) outperformed the ResNet (10.2M) and the WideResNet (11.0M). Because the same node operation was used, the improvement may be attributed to the use of the AOG building block structure. Compared with the DenseNets, the studied AOGNets improved more on C100 while having used less than half the FLOPs for a set of comparable model sizes. Reduced FLOPs of DenseNets may be attributed to the down-sampling applied after each Dense block, while the instant AOGNets are configured to sub-sample at the terminal-nodes.

Ablation Study. An ablation study was also conducted to investigate the effects of removing symmetric child nodes (RS) and/or adding lateral connection (LC). Specifically, symmetric child nodes were removed of OR-nodes in the pruned AOG building blocks.

Table 10 shows results of an ablation study of AOGNets using the mean error rate across 5 runs. In the first two rows of Table 10, AOGNets full structure was used while results of the pruned structure are shown in the last two rows of Table 10. The feature dimensions of the node operations specified accordingly to keep model sizes comparable.

TABLE 10

| Method | #Params | FLOPS | CIFAR 10 | CIFAR 100 |
|---|---|---|---|---|
| AOGNet | 4.24M | 0.65 G | 3.75 | 19.20 |
| AOGNet + LC | 4.24M | 0.65 G | 3.70 | 19.09 |
| AGGNet + RS | 4.23M | 0.70 G | 3.57 | 18.64 |
| AOGNet + RS + LC | 4.23M | 0.70 G | 3.52 | 17.99 |

As Table 10 shows, the two components, RS and LC, improved performance. Indeed, the RS component facilitated higher feature dimensions due to the reduced structural complexity, and the LC component increased the effective depth of nodes on the lateral flows.

Implementation of Compositional Grammatical Neural Network in Other Neural Networks

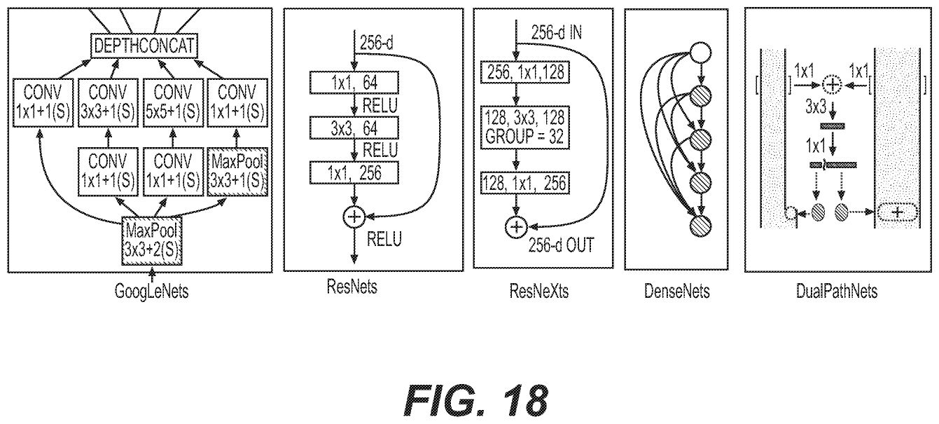

In some embodiments, the one or more compositional grammatical neural network node layers are instantiated in a convolutional neural network selected from the group consisting of GoogLeNets, ResNets, ResNeXts, DenseNets, and DualPathNets. FIG. 18 is a diagram showing examples of alternative building blocks employed in GoogLeNets, ResNets, ResNeXts, DenseNets, and DualPathNets, in accordance with an illustrative embodiment.

In these hand-crafted building blocks, the best practices of finding a good building block adopt the so-called split-transform-aggregate heuristic. The heuristic is motivated by the well-known Hebbian principle in neuroscience, namely, neurons fire together, then wire tighter. Put another way, the wisdom in designing better deep network architectures usually lies in finding a network topology which can support flexible information flows for both exploring new features and exploiting existing features in previous layers. More specifically, we observed the advantages of popular networks are:

InceptionNets or GoogLeNets is described in C. Szegedy, S. Ioffe, and V. Vanhoucke, “Inception-v4, inception-resnet and the impact of residual connections on learning,” CoRR, abs/1602.07261 (2016), which is incorporated by reference herein in its entirety. InceptionNets or GoogLeNets embody the split-transform-aggregate heuristic in a shallow feedforward way. The filter numbers and sizes are tailored for each individual transformation, and the modules are customized stage-by-stage.

The ResNets network (“ResNets”) is described in K. He, X. Zhang, S. Ren, and J. Sun, “Deep residual learning for image recognition,” In IEEE Conference on Computer Vision and Pattern Recognition (CVPR), 2016, which is incorporated by reference herein in its entirety. ResNets provide a eloquent yet effective solution that enables networks to enjoy going either deeper or wider without sacrificing the feasibility of optimization using back-propagation with stochastic gradient descent (i.e., handling the vanishing and/or exploding gradient problems). From the perspective of representation learning, skip-connections within a ResNet contributes to effective features exploitation/reuse. ResNets do not realize the split component.

The ResNeXts network (“ResNeXts”) is described in S. Xie, R. B. Girshick, P. Doll\acute{ }ar, Z. Tu, and K. He, “Aggregated residual transformations for deep neural networks,” CoRR, abs/1611.05431, 2016, which is incorporated by reference herein in its entirety. ResNeXts add the spit component in ResNets and address the drawbacks of the Inception modules using group convolutions in the transformation in a unified way.

The Deep pyramid ResNets network (“Deep pyramid ResNets”) is described in D. Han, J. Kim, and J. Kim, “Deep pyramidal residual networks,” IEEE CVPR, 2017, which is incorporated by reference herein in its entirety. Deep pyramid ResNets extend ResNets by varying the feature map dimension—by increasing it gradually instead of by increasing it sharply at each residual unit with down-sampling.

The DenseNets network (“DenseNets”) are described in G. Huang, Z. Liu, L. van der Maaten, and K. Q. Weinberger, “Densely connected convolutional networks,” In Proceedings of the IEEE Conference on Computer Vision and Pattern Recognition, 2017 and in [19] G. Huang, Y. Sun, Z. Liu, D. Sedra, and K. Q. Weinberger, “Deep networks with stochastic depth,” In Computer Vision ECCV 2016-14th European Conference, Amsterdam, The Netherlands, Oct. 11-14, 2016, Proceedings, Part IV, pages 646-661, 2016, each of which is incorporated by reference herein in its entirety. DenseNets explicitly differentiate between information that is added to the network (i.e., exploration via split-transform) and information that is preserved (i.e., exploitation via aggregation, especially residual connections). From the perspective of representation learning, dense connection with feature maps being concatenated together in DenseNets leads to effective feature exploration.

The DualPathNets network (“DualPathNets”) is described in Y. Chen, J. Li, H. Xiao, X. Jin, S. Yan, and J. Feng, “Dual path networks,” arXiv preprint arXiv:1707.01629, 2017, which is incorporated by reference herein in its entirety. DualPathNets utilize ResNet blocks and DenseNet blocks in parallel to balance feature exploitation and feature exploration.

ResNet (with pre-activation) is described in K. He, X. Zhang, S. Ren, and J. Sun, “Identity mappings in deep residual networks,” In Computer Vision—ECCV 2016—14th European Conference, Amsterdam, The Netherlands, Oct. 11-14, 2016, Proceedings, Part IV, pages 630-645, 2016.

Wide ResNet is described in S. Zagoruyko and N. Komodakis, “Wide residual networks,” In Proceedings of the British Machine Vision Conference 2016, BMVC 2016, York, UK, Sep. 19-22, 2016, 2016.

FractalNet is described in G. Larsson, M. Maire, and G. Shakhnarovich, “Fractalnet: Ultra-deep neural networks without residuals. CoRR, abs/1605.07648, 2016.”

Discussion

Network engineering is one of the most important and challenging hyper-parameter optimization problems in deep learning due to its significant contributions in improving performance. Network architecture search can be posed as a combinatorial search problem in a product space which consists of two sub-spaces: the structure space exploring all directed acyclic graphs with the start node representing input image and the end node representing task loss functions(s), and the operator space exploring all possible functions for implementing nodes in a searched structure. It is an extremely difficult problem due to the exponentially large space and overall highly non-convex non-linear objective functions to be optimized in the search. The system employs convolutional networks in computer vision tasks in reviewing related work. The majority of existing methods are still based on hand-crafted architectures. A promising trend is to automatically learn better architectures with the long-term objective to have theoretical guarantee. So far, hand-crafted ones have better overall performance, especially on largescale datasets such as the ImageNet benchmark.

After more than 20 years since the seminal work 5-layer LeNet5 was proposed, the recent resurgence in popularity of neural networks was triggered by the 8-layer AlexNet with breakthrough performance on ImageNet in 2012. The AlexNet presented two new insights in the operator space: the Rectified Linear Unit (ReLu) and the Dropout. Since then, a lot of efforts has been devoted to learn deeper AlexNetlike networks with the intuition that deeper is better. The VGG Net proposed a 19-layer network with insights on using multiple successive layers of small filters (e.g., 3×3) to obtain the receptive field by one layer with large filter and on adopting smaller stride in convolution to preserve information. A special case, 1×1 convolution, was proposed in the network-in-network for reducing or expanding feature dimensionality between consecutive layers and have been widely used in many networks. The VGG Net also increased computational cost and memory footprint significantly. To address these issues, the 22-layer GoogLeNet introduced the first inception module and a bottleneck scheme implemented with 1×1 convolution for reducing computational cost. The main obstacle of going deeper lies in the gradient vanishing issue in optimization, which is addressed with a new structural design, short-path or skip-connection, proposed in the Highway network popularized by the residual networks, especially when combined with the batch normalization. More than 100 layers are popular design in the recent literature, and even more than 1000 layers trained on large scale datasets such as ImageNet are not rare any more. The Fractal Net provided an alternative way of implementing short path for training ultra-deep networks without residuals. Complementary to going deeper, width matters in residual networks and inception based networks too. Going beyond simple skip-connections, the densely connected network proposed a densely connected network architecture with concatenation scheme for feature reuse and exploration, and the Dual Path Network proposed to combine residuals and densely connections in an alternating way for more effective feature exploration and exploitation. Both skip-connection and dense-connection adapt the sequential architecture to directed and acyclic graph (DAG) structured networks, which were explored earlier in the context of recurrent neural networks (RNN) and ConvNets. Most work focused on boosting spatial encoding and utilizing spatial dimensionality reduction. The squeeze-and excitation module is recently proposed a simple yet effective method focusing on channel-wise encoding. The Hourglass network proposed a hourglass module consisting of both subsampling and up-sampling to enjoy repeated-bottom-up/top-down feature exploration.

The instant AOGNet belongs to hand-crafted architectures in general, but it is guided by intuitively simple yet principled grammar models. It shares some spirit with the inception module, the fractal net and the squeeze-and-excitation module. Because of its hierarchical and compositional structure, AOGNet is capable of balancing depth and width subject to a few hyper-parameters in constructing the AOG building blocks. AOGNet can be used to explore new features and exploit existing features in a compositional way, as well as taking advantage of channel-wise encoding.

Learned network architectures. Even with very strong assumptions (e.g., limited number of stages and limited set of operators), the search space still grows exponentially due to the product space. Bayesian hyper-parameter optimization is one of the popular methods for network architecture search in some restricted space. More recently, by posing the structure and connectivity of a neural network as a variable-length string, the network architecture search work utilizes a recurrent network to generate a such string (i.e., network topology) under the reinforcement learning framework with the validation accuracy of intermediate models as reward. The automatic exploration of network topology entails very high demand on computing resource (e.g., 800 GPUs used in the experiments). Genetic algorithms are also explored in learning network structures. The AdaNet was proposed to learn directed acyclic network structures using a theoretical framework with some guarantee. The instant compositional Grammatical Neural Network unifies all the best practices developed in popular networks such as GoogLeNets, ResNets, ResNeXts, DenseNets, and DualPathNets by deeply integrating hierarchical and compositional grammars. As Mumford pointed out, “Grammar in language is merely a recent extension of much older grammars that are built into the brains of all intelligent animals to analyze sensory input, to structure their actions and even formulate their thoughts.”

Grammar models, described in S. C. Zhu and D. Mumford, “A stochastic grammar of images,” Foundations and Trends in Computer Graphics and Vision, 2(4):259-362, 2006, which is incorporated by reference herein in its entirety, are well known in both natural language processing and computer vision. Image grammar was one of the dominant methods in computer vision before the recent resurgence in popularity of deep neural networks. With the recent resurgence, it is observed that grammar models with more explicitly compositional structures and more analytic and theoretical potential often perform worse than their neural network counterparts. The proposed method bridges the performance gap, which is motivated by and aims to show the advantage of two properties of grammar which are desirable in network engineering: (i) flexible and simple construction of different types of structure topology based on a dictionary of primitives and a set of production rules in a principled way; and (ii) use of highly expressive power and the parsimonious compactness of its explicitly hierarchical and compositional structure. Furthermore, the explainable rigor of grammar could be harnessed potentially to address the interpretability issue of deep neural networks.

The exemplary AOG building block can take advantage of both the exploration of new features and the exploitation/reuse of previously computed features in a hierarchical and compositional way, going beyond the pure skip-connection, the pure dense connection, and their sequential combination. Compared with the best practices developed in popular networks stated above, in the instant AOG building blocks:

(i) Terminal-nodes implement the split-transform heuristic (or group convolutions) as done in GoogLeNets and ResNeXts, but at multiple levels. They also implement the skip-connection at multiple levels. Non-terminal nodes implement aggregation.

(ii) AND-nodes implement DenseNet-like aggregation (i.e., concatenation) for feature exploration.

(iii) OR-nodes implement ResNet-like aggregation (i.e., summation) for feature exploitation.

(iv) The hierarchy facilitates gradual increase of feature channels as in Deep Pyramid ResNets, and also leads to good balance between depth and width in the network architecture.

(v) The compositional structure provides much more flexible information flows than DualPathNets, and naturally balances the depth and width of the network topology.

(vi) The horizontal connections increase the effective depth of nodes on the flow.

To improve performance in practice, the system increases the feature dimensions of node operations in an AOGNet, which also increase the model complexity (the total number of parameters) significantly. To balance the structure and the feature dimensions of node operations, the system can provide a full structure of AOG building blocks or a partial structure.

The simplified AOG building blocks allow for the use of a higher feature dimensions for node operations with the same model complexity to the vanilla ones while having still the advantages of unifying the best practices of popular networks.

Indeed, recently, deep neural networks improved prediction accuracy significantly in many vision tasks, and even obtained superhuman performance in image classification tasks. Much of these progress have been achieved mainly through engineering network architectures which can enjoy increasing representational power (by going either deeper or wider) without sacrificing the feasibility of optimization using back-propagation with stochastic gradient descent (i.e., handling the vanishing and/or exploding gradient problem). On the one hand, although network engineering has been an active part of neural network research since their initial development, the overall architecture are still similar to the seminal work of Fukushimas neocognitron.

Also, whether architecture are hand-crafted or learned through architecture search, the process of finding the right architecture for a task requires significant effort for each individual case. And, the dramatic success does not necessarily speak to its sufficiency, let alone optimality, given the lack of theoretical underpinnings of deep neural networks at present. Different methodologies are worth exploring to enlarge the scope of network architectures, and to potentially address the long-standing interpretability problem. For example, other researchers have recently pointed out a crucial drawback of current convolutional neural networks: according to recent neuroscientific research, these artificial networks do not contain enough levels of structure.

We hope this paper encourages further exploration in learning grammar-guided network generators. The AOG can be easily extended to adopt k-branch splitting rules with k>2. Other types of edges can also be easily introduced in the AOG such as dense lateral connections and top-down connections. Node operations can also be extended to exploit grammar-guided transformation. And, better parameter initialization methods need to be studied for the AOG structure.

Exemplary Computing Device

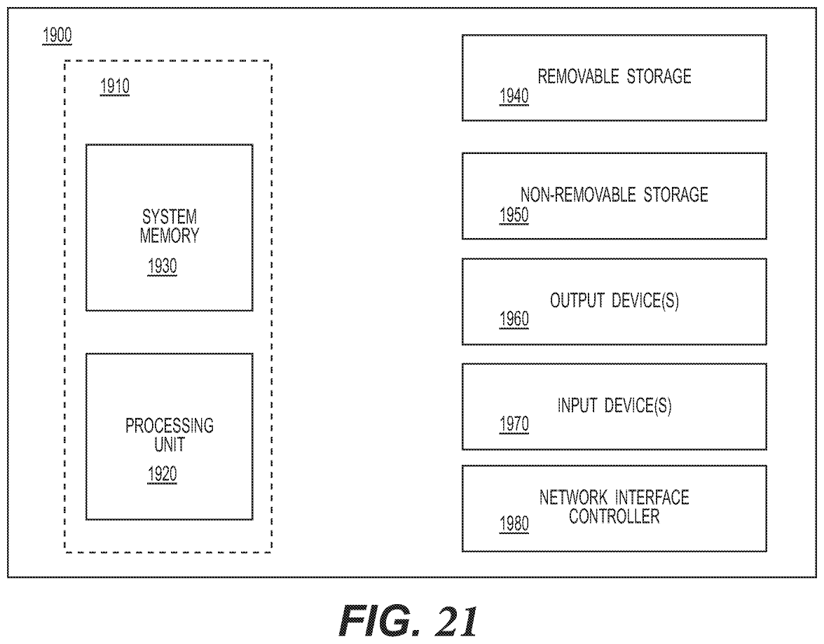

Referring to FIG. 21, an example computing device 1900 upon which embodiments of the AOGNet and AOG building blocks may be implemented is illustrated. For example, each of the AOGNet system 100 and AOG building block 112 described herein may each be implemented as a computing device, such as computing device 1900. It should be understood that the example computing device 1900 is only one example of a suitable computing environment upon which embodiments of the invention may be implemented. Optionally, the computing device 1900 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In an embodiment, the computing device 1900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device 1900 to provide the functionality of a number of servers that is not directly bound to the number of computers in the computing device 1900. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In its most basic configuration, computing device 1900 typically includes at least one processing unit 1920 and system memory 1930. Depending on the exact configuration and type of computing device, system memory 1930 may be volatile (such as random access memory (RAM)), non-volatile (such as read-only memory (ROM), flash memory, etc.), or some combination of the two. This most basic configuration is illustrated in FIG. 21 by dashed line 1910. The processing unit 1920 may be a standard programmable processor that performs arithmetic and logic operations necessary for operation of the computing device 1900. While only one processing unit 1920 is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application specific circuits (ASICs). Thus, while instructions may be discussed as executed by a processor, the instructions may be executed simultaneously, serially, or otherwise executed by one or multiple processors. The computing device 1900 may also include a bus or other communication mechanism for communicating information among various components of the computing device 1900.

Computing device 1900 may have additional features/functionality. For example, computing device 1900 may include additional storage such as removable storage 1940 and non-removable storage 1950 including, but not limited to, magnetic or optical disks or tapes. Computing device 1900 may also contain network connection(s) 1980 that allow the device to communicate with other devices such as over the communication pathways described herein. The network connection(s) 1980 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing device 1900 may also have input device(s) 1970 such as keyboards, keypads, switches, dials, mice, track balls, touch screens, voice recognizers, card readers, paper tape readers, or other well-known input devices. Output device(s) 1960 such as printers, video monitors, liquid crystal displays (LCDs), touch screen displays, displays, speakers, etc. may also be included. The additional devices may be connected to the bus in order to facilitate communication of data among the components of the computing device 1900. All these devices are well known in the art and need not be discussed at length here.

The processing unit 1920 may be configured to execute program code encoded in tangible, computer-readable media. Tangible, computer-readable media refers to any media that is capable of providing data that causes the computing device 1900 (i.e., a machine) to operate in a particular fashion. Various computer-readable media may be utilized to provide instructions to the processing unit 1920 for execution. Example tangible, computer-readable media may include, but is not limited to, volatile media, non-volatile media, removable media and non-removable media implemented in any method or technology for storage of information such as computer readable instructions, data structures, program modules or other data. System memory 1930, removable storage 1940, and non-removable storage 1950 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

In an example implementation, the processing unit 1920 may execute program code stored in the system memory 1930. For example, the bus may carry data to the system memory 1930, from which the processing unit 1920 receives and executes instructions. The data received by the system memory 1930 may optionally be stored on the removable storage 1940 or the non-removable storage 1950 before or after execution by the processing unit 1920.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

Embodiments of the methods and systems may be described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Use of the phrase “and/or” indicates that anyone or any combination of a list of options can be used. For example, “A, B, and/or C” means “A”, or “B”, or “C”, or “A and B”, or “A and C”, or “B and C”, or “A and B and C”. As used in the specification, the singular forms “a,” “an” and “the” include plural referents unless the context clearly dictates otherwise. Moreover, titles or subtitles may be used in this specification for the convenience of a reader, which shall have no influence on the scope of the disclosed technology. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted for the sake of clarity. It is intended that each term contemplates its broadest meaning as understood by those skilled in the art and includes all technical equivalents that operate in a similar manner to accomplish a similar purpose.

It is to be understood that the mention of one or more steps of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

In some embodiments, the AOGNet and AOG building blocks can be applied to a broad range of applications such as image classification, object detection (e.g., in video surveillance), among other. The AOGNet can AOG building block can be used for an structured learning and training in which a task to be solved is collected via a set of a source labeled examples.

Throughout this application, and at the end thereof, various publications are referenced. The disclosures of these publications in their entireties are hereby incorporated by reference into this application in order to more fully describe the state of the art to which the methods and systems pertain.

1. A computer-implemented method comprising:
instantiating one or more compositional grammatical neural network node layers, wherein at least one of the one or more compositional grammatical neural network node layer comprises a AND-OR grammar building block,
wherein the AND-OR grammar building block comprises an input that maps N groups of input-able features from one or more feature channels, and
wherein the AND-OR grammar building block comprises a graph of stacked and interconnected plurality of AND nodes and plurality of OR nodes that connects in a set of combinations of AND nodes and OR nodes to the N groups of inputted features of each of the one or more feature channels.

2. The computer-implemented method of claim 1, wherein the graph of interconnected plurality of AND nodes and plurality of OR nodes are configured in a plurality of stacked stages, including a first stage followed by a second stage, wherein the first stage comprises at least one AND-node, and wherein the second stage comprises at least one OR-node.

3. The computer-implemented method of claim 1, wherein the graph of interconnected plurality of AND nodes and plurality of OR nodes are configured in a plurality of stacked stages, including a first stage followed by a second stage, wherein the first stage comprises at least one OR-node, and wherein the second stage comprises at least one AND-node.

4. The computer-implemented method of claim 3, wherein the first stage comprises a first OR-node and a second OR-node, wherein the first OR-node is connected to a portion of the input, and wherein the second OR-node is connected to another portion of the input and to the first OR-node.

5. The computer-implemented method of claim 1, wherein the first stage comprises a first OR-node and a second OR-node, wherein the first OR-node is connected to a portion of the input, and wherein the second OR-node is connected to another portion of the input.

6. The computer-implemented method of claim 1, wherein the first stage comprises a first OR-node and a second OR-node, wherein the first OR-node is connected to a portion of the input, and wherein the second OR-node is connected to another portion of the input.

7. The computer-implemented method of claim 1, wherein the AND-OR grammar building block comprises a first hyper-parameter associated with a number of N groups of input-able features.

8. The computer-implemented method of claim 1, wherein the AND-OR grammar building block comprises a second hyper-parameter associated with a branching factor for each AND-nodes in the AND-OR grammar building block.

9. The computer-implemented method of claim 1, wherein the AND-OR grammar building block comprises a third hyper-parameter associated with i) phase structure grammar only and ii) a combination of phase structure grammar and dependency grammar.

10. The computer-implemented method of claim 1, wherein the AND-OR grammar building block comprises a fourth hyper-parameter associated with i) full phrase structure and ii) a partial phrase structure that do not include syntactically symmetric child nodes for OR-nodes.

11. The computer-implemented method of claim 1, wherein the one or more compositional grammatical neural network node layers are instantiated in a convolutional neural network selected from the group consisting of GoogLeNets, ResNets, ResNeXts, DenseNets, and DualPathNets.

12. The computer-implemented method of claim 1, wherein the generated deep neural network structure comprises a second compositional grammatical neural network node layer, wherein the second compositional grammatical neural network node layer comprises a AND-OR grammar building block, wherein the AND-OR grammar building block comprises an input that maps N groups of input-able features from one or more feature channels, and wherein the AND-OR grammar building block comprises a graph of stacked and interconnected plurality of AND nodes (e.g., node configured to concatenate features from connected child nodes) and plurality of OR nodes (e.g., node configured to element-wise sum features from connected child nodes) that connects in a set of combinations of AND nodes and OR nodes to the N groups of inputted features of each of the one or more feature channels

13. The computer-implemented method of claim 1, wherein the generated deep neural network structure comprises one or more Conv-BatchNorm-ReLu stage that connects to a first instantiated compositional grammatical neural network node layer.

14. The computer-implemented method of claim 1, wherein the one or more compositional grammatical neural network nodes comprises a second AND-OR grammar building block.

15. The computer-implemented method of claim 1, further comprising:
classifying an image using the instantiated one or more neural network nodes.

16. The computer-implemented method of claim 1, further comprising:
classifying a linguistic text body using the instantiated one or more neural network nodes.

17. The computer-implemented system of any one of claim 1, wherein an N group of inputted features of at least one of the one or more feature channels includes at least 2 groups.

18. A computer-implemented method comprising:
a processor; and
a memory having instructions stored thereon, wherein execution of the instructions by the processor causes the processor to:
instantiate one or more compositional grammatical neural network node layers, wherein at least one of the one or more compositional grammatical neural network node layer comprises a AND-OR grammar building block,
wherein the AND-OR grammar building block comprises an input that maps N groups of input-able features from one or more feature channels, and
wherein the AND-OR grammar building block comprises a graph of stacked and interconnected plurality of AND nodes and plurality of OR nodes that connects in a set of combinations of AND nodes and OR nodes to the N groups of inputted features of each of the one or more feature channels.

19. A non-transitory computer readable medium comprising instructions stored thereon, wherein execution of the instructions by a processor causes the processor to:
instantiate one or more compositional grammatical neural network node layers, wherein at least one of the one or more compositional grammatical neural network node layer comprises a AND-OR grammar building block,
wherein the AND-OR grammar building block comprises an input that maps N groups of input-able features from one or more feature channels, and
wherein the AND-OR grammar building block comprises a graph of stacked and interconnected plurality of AND nodes and plurality of OR nodes that connects in a set of combinations of AND nodes and OR nodes to the N groups of inputted features of each of the one or more feature channels.

20. (canceled)
